(19) United States
(12) Patent Application Publication
(10) Pub. No.: US 2019/0158370 A1
(43) Pub. Date: May 23, 2019

(54) COMPUTING SYSTEM AND METHOD FOR INTELLIGENT IOE INFORMATION FRAMEWORK

(71) Applicant: Electronics and Telecommunications Research Institute, Daejeon (KR)

(72) Inventors: Tae Wan YOU, Daejeon (KR); Jung Ha HONG, Daejeon (KR); Kwi Hoon KIM, Daejeon (KR); Yong Geun HONG, Daejeon (KR); Hyeon Sik YOON, Daejeon (KR); Wan Seon LIM, Daejeon (KR); Min Suk KIM, Daejeon (KR); Tae Hwan KIM, Daejeon (KR)

(73) Assignee: Electronics and Telecommunications Research Institute, Daejeon (KR)

(21) Appl. No.: 16/158,109

(22) Filed: Oct. 11, 2018

(30) Foreign Application Priority Data
Nov. 17, 2017 (KR) 10-2017-0154021
Sep. 6, 2018 (KR) 10-2018-0106670

(51) Int. Cl. H04L 12/26; H04L 12/24; H04L 29/08; H04W 4/38

(52) U.S. Cl. CPC H04L 43/065; H04L 41/0853; H04L 43/0811; H04L 41/16; H04W 4/38; H04L 67/303

(57) ABSTRACT

A computing system for an intelligent Internet of Everything (IoE) information framework according to the present invention includes: a plurality of edge computing platforms each comprising an edge networking node for supporting connectivity with a terminal, an intelligent computing node for analyzing data of the terminal through the edge networking node, and an edge gateway node for information-centric networking within an edge computing platform and Internet protocol networking with an outside of the edge computing platform; and an edge identifier management node configured to generate mapping information by mapping the plurality of edge computing platforms with identifiers of the terminal and data.

### CROSS-REFERENCE TO RELATED APPLICATION

This application claims priority to and the benefit of Korean Patent Application No. 10-2017-0154021, filed on Nov. 17, 2017, and Korean Patent Application No. 10-2018-0106670, filed on Sep. 6, 2018, the disclosure of which is incorporated herein by reference in its entirety.

### BACKGROUND

### 1. Field of the Invention

The present invention relates to a computing system and method for an intelligent Internet of Everything (IoE) information framework.

### 2. Discussion of Related Art

Recently, various technologies have been developed and provided to offer connectivity for collecting a great deal of data generated in a number of objects in Internet of Things (IoT) and analyzing and processing the collected data.

However, just Internet and such Internet protocol (IP) technologies, such as Internet protocol version 6 (IPv6), constrained application protocol (CoAP), and a technology using the central cloud server, have limits to processing the data from a great deal of IoT objects or supporting expandable connectivity.

Further, the existing IoT platforms have been also developed as being specialized to different technologies and service domains, and it is thus difficult to develop an inclusive solution.

Therefore, there is a need for an integrated framework to effectively support the connectivity and mobility under a resource constrained environment and networking constrained environment of many IoT things and collect and process a great deal of data generated in these things through a distributed structure.

### SUMMARY OF THE INVENTION

An embodiment of the present invention is directed to providing a computing system and method for an intelligent IoE information framework, which includes a function of managing and controlling a distributed edge/fog intelligent networking platform, on the basis of an information-centric networking-based edge/fog intelligent networking platform for offering connectivity of supporting expandability, mobility, and real time (low latency) to a lot of things.

However, technical problems to be solved by the following embodiments are not limited to the above described problems, and may include other technical problems.

As a technical means for solving the foregoing technical problems, a computing system for an intelligent Internet of Everything (IoE) information framework according to a first aspect of the present invention includes: a plurality of edge computing platforms each comprising an edge networking node for supporting connectivity with a terminal, an intelligent computing node for analyzing data of the terminal through the edge networking node, and an edge gateway node for information-centric networking within an edge computing platform and Internet protocol networking with an outside of the edge computing platform; and an edge identifier management node configured to generate mapping information by mapping the plurality of edge computing platforms with identifiers of the terminal and data.

The data of the terminal may be stored in a temporary storage and classified according to the kinds of data and service, and the classified data may be stored in a data storage in the edge computing platform and analyzed through the intelligent computing node.

The edge networking node may register identifier information as the identifier information is received from the terminal and connect with the terminal through bootstrapping for transmitting a response message.

The edge networking node may transmit and register the identifier information of the terminal to the intelligent computing node, and the intelligent computing node may transmit and register its own identifier information and the identifier information of the terminal to the edge identifier management node to maintain the mapping information.

The edge networking node of the edge computing platform at a user terminal among the plurality of edge computing platforms may receive identifier information of the intelligent computing node of the edge computing platform at an Internet of Things (IoT) terminal, in which the data of the IoT terminal is stored, from the edge identifier management node through the intelligent computing node as a message for requesting for the data of the IoT terminal to be received from the user terminal, and receive and provide one or more of data of the IoT terminal and the analyzed data from the intelligent computing node of the edge computing platform at the IoT terminal to the user terminal on the basis of the identifier information.

The edge gateway node may receive a message requesting the data of the IoT terminal from a cloud server, convert the received message into a message based on the information-centric networking, transmit the converted message to the intelligent computing node, receive one or more of data of the IoT terminal and the analyzed data from the intelligent computing node, convert the received data into a message based on the Internet protocol networking, and provide the converted message to the cloud server.

The edge gateway node may receive a data processing model corresponding to a service profile from the cloud server as the service profile is transmitted to the cloud server through the Internet protocol networking, and the intelligent computing node may analyze the data on the basis of the received data processing model.

The data analyzed by the intelligent computing node may be provided for an operation of the terminal or transmitted to the cloud server through the edge gateway node.

When a first edge networking node to which a user terminal is connected is switched over to a second edge networking node as the user terminal moves within the edge computing platform, the second edge networking node may receive identifier information of the intelligent computing node from the edge identifier management node, transmit a message for requesting the data of the IoT terminal to the intelligent computing node on the basis of the received identifier information, and forward one or more of the data of the IoT terminal and the analyzed data.

When a first edge networking node to which an IoT terminal is connected is switched over to a second edge networking node as the IoT terminal moves within the edge computing platform, the second edge networking node may register the IoT terminal to an intelligent computing node, and the intelligent computing node may register the IoT terminal to the edge identifier management node.

The intelligent computing node may transmit a message to the second edge networking node to request the data of the IoT terminal and acquire the data of the IoT terminal.

The edge identifier management node may generate the mapping information by mapping the identifier information of the IoT terminal and the identifier information of the intelligent computing node so as to perform a process with regard to a data request of the user terminal to the IoT terminal.

When an IoT terminal moves from a first edge computing platform to a second edge computing platform among the plurality of edge computing platforms, the edge networking node of the second edge computing platform may register the IoT terminal to the intelligent computing node, and the intelligent computing node of the second edge computing platform may register the IoT terminal to the edge identifier management node.

The intelligent computing node of the second edge computing platform may transmit its own identifier and the identifier of the IoT terminal to the edge identifier management node, and the edge identifier management node may map the identifier of the IoT terminal and the identifier of the intelligent computing node to generate the mapping information.

As the intelligent computing node of the second edge computing platform transmits a message for requesting data of the IoT terminal through the edge networking node of the second edge computing platform, the IoT terminal moved to the second edge computing platform may provide the data to the intelligent computing node of the second edge computing platform through the edge networking node of the second edge computing platform.

As movement of the IoT terminal to the second edge computing platform is completed, the intelligent computing node at the user terminal may receive the identifier of the intelligent computing node of the second edge computing platform through the edge identifier management node and acquire the data of the IoT terminal through the intelligent computing node of the second edge computing platform.

The edge networking node of the second edge computing platform may make a request to the edge networking node of the first edge computing platform and forward one or more of the data of the IoT terminal and the analyzed data, which are stored in the intelligent computing node of the first edge computing platform, to the intelligent computing node of the second edge computing platform.

According to another aspect of the present invention, a computing method of an intelligent Internet of Everything (IoE) information framework includes: receiving data of a terminal using an edge networking node for supporting connectivity with the terminal; collecting and analyzing the received data of the terminal using an intelligent computing node; and transmitting the analyzed data to a cloud server through an edge gateway node or providing the analyzed data as operation data for the terminal through the intelligent computing node, wherein the intelligent IoE information framework comprises a plurality of edge computing platforms, each of which comprises the edge networking node, the intelligent computing node, and the edge gateway node, and an edge identifier management node configured to generate mapping information by mapping the plurality of edge computing platforms with identifiers of the terminal and data.

According to still another aspect of the present invention, an edge computing platform apparatus in an intelligent IoE information framework includes: an edge networking node for supporting connectivity with a terminal; an intelligent computing node for analyzing data of the terminal through the edge networking node; and an edge gateway node for information-centric networking and Internet protocol networking with an outside.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram of a computing system for an intelligent Internet of Everything (IoE) information framework according to one embodiment of the present invention;

FIG. 2 is a view illustrating a data processing flow using the intelligent IoE information framework;

FIG. 3 is a view illustrating nodes and components for data and networking process on the intelligent IoE information framework;

FIG. 4 is a view illustrating a procedure of processing intelligent IoE information;

FIG. 5 is a view illustrating a procedure of using an IoE data analysis model provided through a cloud server;

FIG. 6 is a view illustrating a procedure of supporting intelligent Internet of Things (IoT)/IoE networking;

FIG. 7 is a view illustrating a bootstrapping procedure between an IoT terminal and an edge networking node;

FIG. 8 is a view illustrating a bootstrapping procedure between an edge networking node and an intelligent computing node;

FIG. 9A and FIG. 9B are a view illustrating a procedure of acquiring data of an IoT terminal using a user terminal;

FIG. 10 is a view illustrating a procedure of acquiring data of an IoT terminal using an external cloud server;

FIG. 11A and FIG. 11B are a view illustrating a procedure of supporting mobility of a user terminal and supporting a seamless handover;

FIG. 12 is a view illustrating a procedure of supporting mobility of an IoT terminal on an edge computing platform;

FIG. 13 is a view illustrating a data mobility supporting procedure and a seamless handover procedure between a plurality of edge computing platforms;

FIG. 14 is a flowchart of a computing method for an intelligent IoE information framework;

FIG. 15 is a view illustrating a data processing scenario in two domains including the same data;

FIG. 16 is a view illustrating a privacy guarantee service supported in a smart healthcare system;

FIG. 17 is a view illustrating a procedure of supporting an urgent message process in a smart factory system;

FIG. 18 is a view illustrating a procedure of supporting a data path bypassing process using a mobile terminal;

FIG. 19 is a view illustrating a procedure of supporting generation of a machine learning model by sorting and combining data; and

FIG. 20 is a view illustrating a virtualization-based platform and framework.

### DETAILED DESCRIPTION OF EXEMPLARY EMBODIMENTS

Hereinafter, embodiments of the present invention will be described in detail with reference to the accompanying drawings so as to be easily materialized by a person having an ordinary skill in the art to which the present invention pertains. However, the present invention may be realized in various different forms and is not limited to the embodiments set forth herein. Further, to clearly describe the present invention, parts unrelated to the descriptions are omitted in the drawings.

In this disclosure, when a part “includes” an element, it means, not the exclusion of another element, but the presence or addition of other elements unless otherwise stated.

The present invention relates to a computing system 1 and method for an intelligent Internet of Everything (IoE) information framework.

Currently, a resource-constrained Internet of Things (IoT) environment includes an environment constrained by a device itself and an environment constrained by networking technology. In a case of the device (things), the constrained environment includes constraint on performance of a central processing unit (CPU) and capacity of a memory. In a case of the networking technology, the constrained environment includes constraints on wireless networking technology, such as a low power wide area (LPWA) network and a low power and lossy network (LLN).

Therefore, the related art supports a networking and data transmission service with the existing Internet technology, i.e., the transmission control protocol/Internet protocol (TCP/IP) or user datagram protocol/Internet protocol (UDP/IP) stack, in order to provide connectivity in such a resource-constrained IoT environment.

Further, the related art uses, not the existing Internet protocol, i.e. Internet protocol version 4 (IPv4), but Internet protocol version 6 (IPv6) to allocate IP addresses to a great deal of IoT devices; newly standardizes and develops a convergence layer between the Ipv6 layer and a media access control (MAC) layer to have the LPWA and similar new wireless technology; and provides a constrained application protocol (CoAP) or similar technology, which makes hypertext transfer protocol (HTTP) lightweight for an application layer.

However, such a conventional IPv6-centric connectivity support still has shortcomings of the conventional IP technology. In a particular case of a vehicle, mobility support is required to store video and internal sensor data in the central server or the like, but the existing Internet technology still has problems in that a separate mobility support protocol has to be additionally installed and an infrastructure has to be also additionally constructed.

Further, the existing Internet technology makes overhead for connection settings in terms of transmitting a message like a multicast protocol since it is a protocol technology designed for a stationary terminal and server. In particular, the existing Internet technology makes overhead because an additional message has to be transmitted and received for transport layer security (TLS), datagram transport layer security (DTLS), etc. for communication channel security of an application service.

Otherwise, it is expected that a number of IoT devices will be increased more than 10¹⁰ in the future, and therefore the needs of expandability, effective networking technology, and computing platform technology are continuously on the rise to process great deals of data generated by such devices. Accordingly, an edge/fog computing technology for processing the data close to a user and an IoT device has been popularized.

The edge computing includes a mobile edge computing (MEC) technology for mobile communication, in which a function or the like necessary for the service are directly performed in a device, an access gateway, a base station, etc. The fog computing refers to a distributed computing platform positioned between a device (in particular, an IoT device) and a central cloud computing structure provided through Internet, which has recently been technologically discussed.

However, in most cases, the edge computing and the fog computing are used together in parallel rather than being used with their technical differences. Therefore, the edge computing described according to the present invention may involve the fog computing technology.

In such a circumstance that various edge/fog computing technologies are present with a great deal of IoT platforms developed for various existing IoT service fields, additional research, developments, and standardization activities are continuously ongoing to integrate the technologies and support interoperability (inter-working).

For instance, services and technologies have been developed with respect to each of individual IoT platforms for a great deal of IoT services such as a smart city, a smart factory, smart healthcare, etc. However, as a result, a lot of IoT platforms are flooding into the market without sharing a common technology, and it is thus expected that costs for development and maintenance will be continuously increased.

In particular, the IoT devices are developed to operate with a gateway or an actuator and therefore become obstacles to industrialization since they are not free from a specific company product and its dedicated service.

Meanwhile, there are activities for supporting a united IoT platform through international standardization, and platforms such as IoTivity of open connectivity foundation (OCF), one machine to machine (oneM2M), etc. have been developed. However, they are not regarded as the united IoT platform yet.

In conclusion, just the Internet and similar IP technologies, such as IPv6, CoAP, and the technology using the central cloud server are insufficient to process data from many IoT terminals and support expandable connectivity. Further, the existing IoT platforms are also developed as being specialized to different technologies and service domains, and thus have shortcomings of having difficulty in developing an inclusive solution.

Therefore, there is a need for a technology for collecting and processing data in an area near to a user and a data generation area, such as the edge/fog computing technology or the like for supporting effective connectivity and mobility in a resource constrained environment and networking constrained environment with many IoT devices and collecting and processing a great deal of data generated in these devices through a distributed structure.

Further, there is a need for an inclusive framework, which is applicable to various service domains and even provides the technologies for networking, security, and the like through a simple representational state transfer (RESTful) messaging technique used in the web and similar application services to be compatible with technologies such as the existing IoT platform or the cloud server.

To solve such a problem, the computing system and method for the intelligent IoE information framework according to one embodiment of the present invention collects, stores and processes information generated in the things, controls the things or transmits analysis results and the like to a cloud server, and manages and controls distributed edge computing platforms on the basis of an information-centric networking-based edge computing platform for providing connectivity supporting expandability, mobility, and real time capabilities (low latency) to more than 10¹⁰ things.

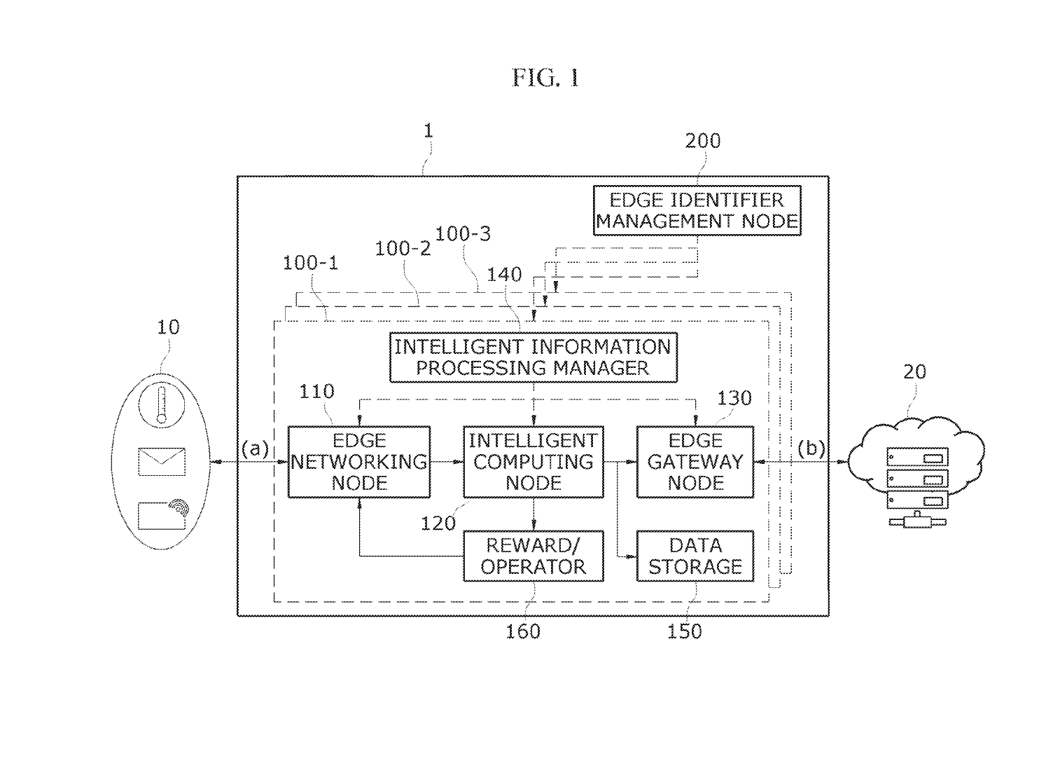

Below, a computing system 1 for an intelligent IoE information framework according to one embodiment of the present invention will be described with reference to FIGS. 1 to 13.

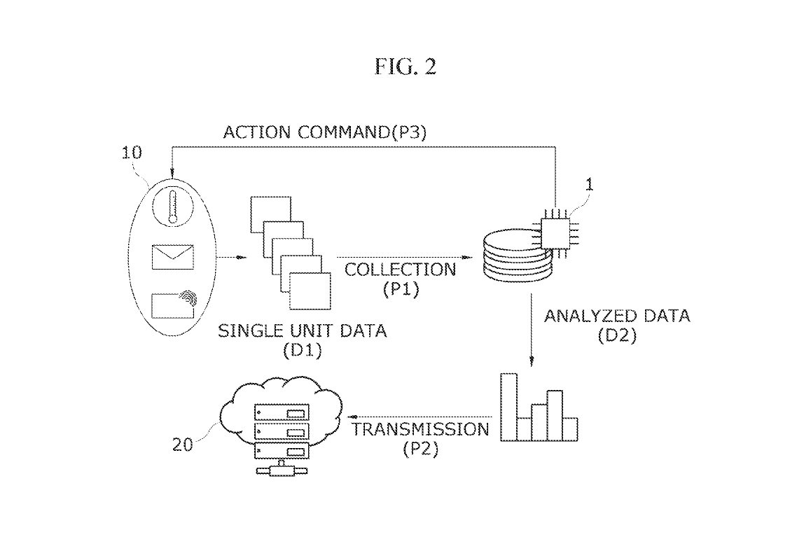

FIG. 1 is a block diagram of a computing system 1 for an intelligent IoE information framework according to one embodiment of the present invention. FIG. 2 is a view illustrating a data processing flow using the intelligent IoE information framework.

The computing system 1 for the intelligent IoE information framework according to one embodiment of the present invention includes a plurality of edge computing platforms 100, and an edge identifier management node 200 developed and arranged in an edge network and provided for interworking between different edge computing platforms 100.

In this case, the intelligent IoE information framework is positioned between proprietary thing networks (a) where a wireless network section is established with resource-constrained terminals 10 of the IoT and Internet (b) where a general cloud server 20 and the like are provided.

Meanwhile, the terminal described in one embodiment of the present invention includes both the IoT terminal 10 and a user terminal 30, and the following descriptions will be made by distinguishing between the IoT terminal 10 and the user terminal 30 as necessary.

The plurality of edge computing platforms 100-1, 100-2, . . . , 100-n each includes an edge networking node 110, an intelligent computing node 120 and an edge gateway node 130.

In this case, the nodes 110, 120, and 130 according to one embodiment of the present invention may be provided as not only physical hardware elements independent of one another, but also software virtualized in one or more physical hardware elements. That is, each of the nodes 110, 120, and 130 in the edge computing platform 100 provided as a physical server may be configured in the form of a separate virtualized program. Further, components 140, 150, and 160 connected to the nodes 110, 120, and 130 may be also provided as independent hardware elements or provided in the form of virtualized software included in the nodes.

In this case, when the physical hardware element is a server, the server may include a memory (not shown) where a program for performing functions is stored, and a processor (not shown) for executing the program stored in the memory.

In this case, the memory inclusively refers to a nonvolatile storage device, in which stored information is retained even when power is not supplied, and a volatile storage device. For example, the memory may include a NAND flash memory such as a compact flash (CF) card, a secure digital (SD) card, a memory stick, a solid-state drive (SSD), a micro SD card, etc.; a magnetic computer storage device such as a hard disk drive (HDD), etc.; and an optical disc drive such as a compact disc read only memory (CD-ROM), a digital versatile disc (DVD)-ROM, etc.

Meanwhile, the function nodes 110, 120, 130 and the components 140, 150, 160 according to one embodiment of the present invention may be connected by information-centric networking (ICN) technology virtualized corresponding to developed forms of the actual nodes, inter-process communication (IPC) using IP technology, or the like.

With this connectivity, according to one embodiment of the present invention, the thing networks and the nodes 110, 120, 130 and the components 140, 150, 160 are connected so as to collect the IoT data and perform jobs of effectively processing, analyzing, etc. the collected data.

Further, data of the IoT terminal 10 or the analyzed data may be transmitted to the cloud server 20 through the Internet (b), or a function for controlling operations of the terminals 10 may be directly performed, thereby being applicable to various IoT/IoE service domains.

First, the edge networking node 110 implements a function for enabling the information-centric networking node so that the IoT terminals 10 can support the connectivity. That is, the edge networking node 110 according to one embodiment of the present invention refers to a networking node that basically supports the existing ICN, which can directly support the connectivity through a technology of two layers (Layer 2 MAC) among open system interconnection (OSI) communication layers without an IP protocol.

Further, the TCP, UDP, and CoAP as well as the IP protocol may be supported for connectivity and networking interoperability with various IoT terminals 10.

The edge networking node 110 is a networking node for the thing network of the edge computing platform 100 and is connected to the edge identifier management node 200 through a control channel Through this channel, the edge networking node 110 does not manage the states of all the terminals 10 whenever the terminals 10 move, but provides identifier and data information of the terminals 10 to the edge identifier management node 200, thereby managing the mobility of the data and a stateless terminal 10.

Meanwhile, a plurality of edge networking nodes 110 may be provided on one edge computing platform 100.

The intelligent computing node 120 collects the data of the IoT terminal 10 through the edge networking node 110 and analyzes the collected data. That is, the intelligent computing node 120 not only directly collects the data of the IoT terminals 10 but also analyzes and processes the data, thereby implementing a function for determining the following processing procedure.

To this end, the intelligent computing node 120 may have machine learning or a similar platform. Further, the intelligent computing node 120 makes the physical terminals interwork through a clustering technique for the purpose of the expandability, and the intelligent computing node 120 may be dynamically generated in the form of a virtual machine and supported so that various data processing functions can be implemented as necessary.

Meanwhile, data generated in an actual sensor and a similar IoT terminal 10 may include not only sensor information but also media data, real-time data, etc. For example, when the data generated in the IoT terminal 10 is the real-time data generated in sequence, the intelligent computing node 120 may support an online traffic analysis (real-time message process) or a similar function to dynamically analyze the real-time data.

To this end, according to one embodiment of the present invention, an intelligent information processing manager 140 may be provided as a component. The intelligent information processing manager 140 intervenes in a general procedure for transmitting, analyzing and processing the IoT data, and supports real-time message processing, analysis, etc. Further, the intelligent information processing manager 140 implements functions for connecting, managing and controlling the nodes 110, 120, 130 within the edge computing platform 100.

Meanwhile, the intelligent information processing manager 140 may be independent of the intelligent computing node 120, and the corresponding functions may be implemented in the intelligent computing node 120.

Although the data analyzed by the intelligent computing node 120 contains some of meanings, it is necessary to transmit the analyzed data to the external cloud server 20 and be subjected to aggregation, analysis and process for big data.

To this end, the edge gateway node 130 supports the thing network, the ICN commonly used in the edge computing platform, and Internet protocol networking with the outside of the edge computing platform.

That is, the edge gateway node 130 implements functions of analyzing a message and rapidly transmitting an analysis result in order to process data of the cloud server 20 located at the outside of the edge computing platform 100.

In addition to the nodes 110, 120, and 130, the internal components of the edge computing platform 100 may include the intelligent information processing manager 140, a data storage 150 for storing the analysis data, and a reward/operator 160 carrying out an action command corresponding to an actual service and determining a policy through a reward.

After collecting and analyzing the data received from the IoT terminals 10, the analysis result may be immediately transmitted to the cloud server 20. Alternatively, the analysis result may be stored in the data storage 150 in accordance with circumstances of the relevant service.

Alternatively, the reward/operator 160 may offer a reward of taking an actual action according to the policy based on the service and issue an action command to the IoT terminal 10 via the edge networking node 110.

Lastly, the edge identifier management node 200 generates mapping information obtained by mapping the plurality of edge computing platforms 100, the terminal 10, and the identifier of the data. That is, the edge identifier management node 200 refers to a node for supporting the mobility of the IoT terminals 10 and the mobility of the data among the plurality of edge computing platforms 100 and identifies the IoT terminal 10 and the data with the identifiers.

Further, the mapping information for mapping and managing the identifiers for the IoT terminal 10 and the data, and the identifier for the edge computing platform 100, in particular, the edge networking node 110 in the edge computing platform 100 is generated to thereby support the mobility of the terminal 10 and the data.

With the configuration shown in FIG. 1, a data processing flow to be ultimately applied to the IoT/IoE service domain by the computing system 1 for the intelligent IoE information framework is as shown in FIG. 2.

As a kind of sensor, the IoT terminals 10 are configured to generate single unit data D1, such as temperature, humidity, etc., in which the single unit data D1 is meaningless raw data in itself.

The computing system 1 for the intelligent IoE information framework according to one embodiment of the present invention collects the raw data D1 about different types, meanings, and environments from the IoT domains (P1) and generates analyzed data D2 to offer an IoT/IoE service by analyzing and filtering the collected raw data D1.

Further, the computing system 1 for the intelligent IoE information framework implements a function for an ‘action command (P3)’ to make the analyzed data D2 be transmitted to the cloud server 20 ‘(P2)’ again or immediately applied to the IoT domain. Therefore, the intelligent IoE information framework according to one embodiment of the present invention can be a framework for intelligently processing and applying the data differently from the existing IoT data processing scheme.

Below, detailed configurations and functions to be carried out in the computing system 1 for the intelligent IoE information framework will be described according to items.

[Data on Intelligent IoE Information Framework and Configuration of Networking Component]

The intelligent IoE information framework according to one embodiment of the present invention provides not only the function for processing IoE information as shown in FIG. 1 but also the connectivity for offering data from a thing network. Further, the intelligent IoE information framework implements a function as a networking platform for providing networking between the nodes 110, 120, and 130 and the components 140, 150, and 160 in the intelligent IoE information framework and for providing networking with the cloud server 20 or the like on the Internet.

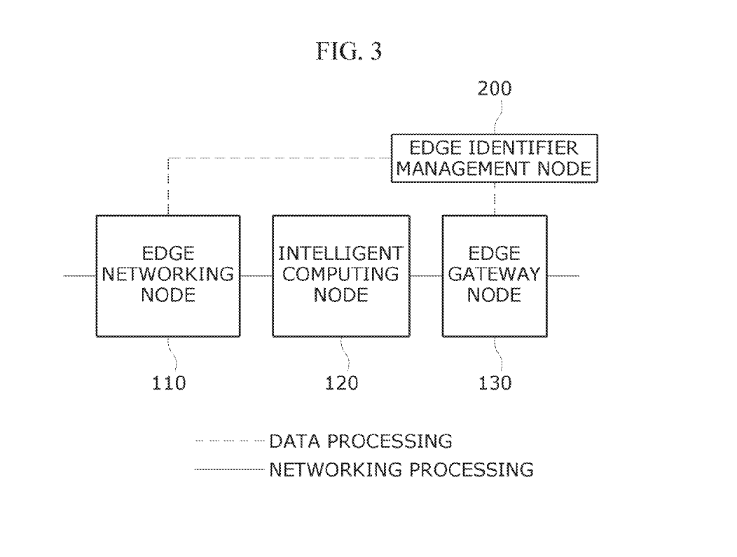

FIG. 3 is a view illustrating nodes and components for data and networking processing on the intelligent IoE information framework;

The edge networking node 110 serves to collect data from the IoT terminal 10 and supports the connectivity of the IoT terminals 10.

The edge gateway node 130 transmits the data analyzed by the intelligent computing node 120 and supports the connectivity with the cloud server 20 through the external Internet (b).

The intelligent computing node 120 for the intelligent data process has functions for analyzing and processing most data. The intelligent computing node 120 may include the component of the intelligent information processing manager 140 for implementing a management function in order to allocate and provide computing resources by clustering as many edge terminals 10 as necessary. The intelligent information processing manager 140 may actually be operated by a dedicated server device such as a bare metal server.

Further, the intelligent IoE information framework basically employs an ICN-based networking technology for connection between the nodes and includes the edge identifier management node 200 for dynamically mapping the identifier needed for the networking and the identifier needed for various purposes.

Below, the functions implemented by the nodes and the components will be described in detail.

[Intelligent IoE Information Processing Procedure]

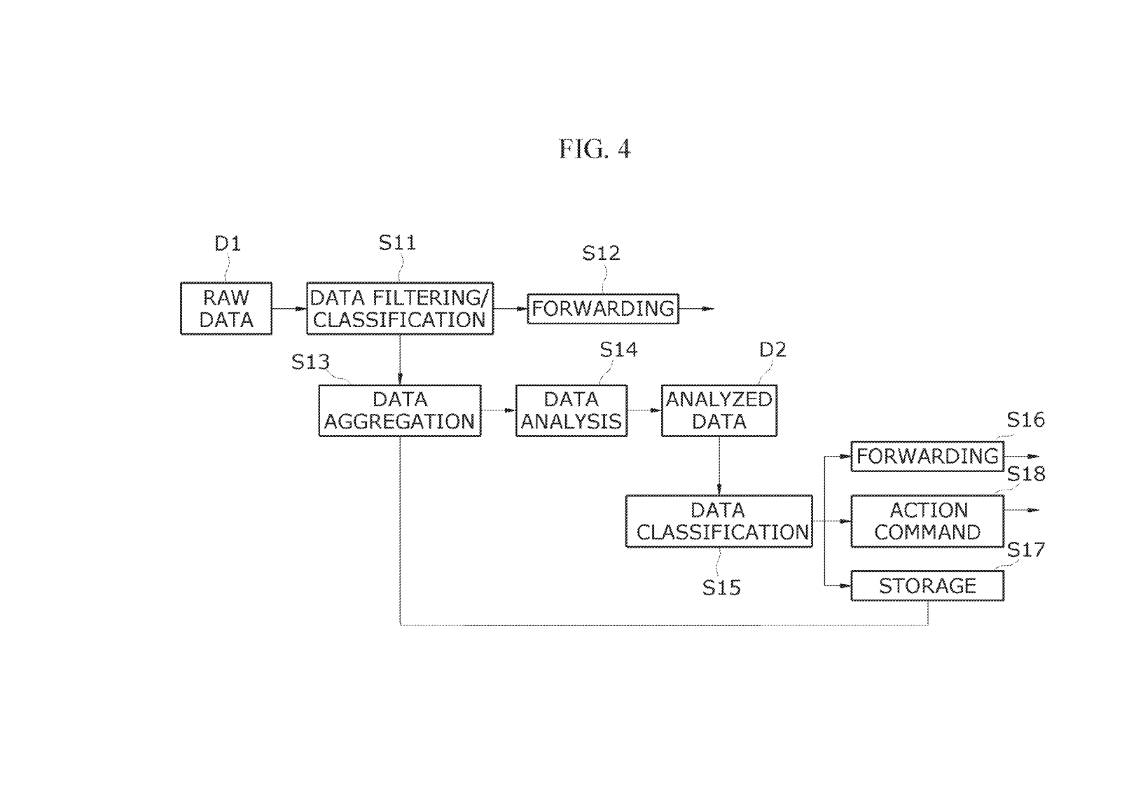

FIG. 4 is a view illustrating a procedure of processing intelligent IoE information.

The computing system 1 for the intelligent IoE information framework according to one embodiment of the present invention processes data (raw data or single unit data) D1, which is generated from the IoT terminals 10, through the procedure shown in FIG. 4.

First, the data D1 offered from the IoT terminal 10 needs to be subjected to real-time analyzing and filtering. Therefore, the intelligent computing node 120 stores the data D1, which is generated in real time, in a memory queue or a similar temporary storage using a service protocol, a data profile, identifier information (a data identifier given in the form of a uniform resource identifier (URI)) and similar information. Then, the temporarily stored data is subjected to an analysis based on machine learning and an artificial intelligent platform. In this procedure, the intelligent computing node 120 can classify the kind of data and the kind of service (classification process, S11).

Further, by filtering pieces of data, which have to be continuously and accumulatively stored for analysis (filtering process, S11), it is possible to immediately and directly forward the filtered data to the cloud server 20 together with a service model using the existing IoT terminal 10 or cloud server 20 (S12, S16).

Then, the previously processed real time data is stored in the data storage 150 according to results of analysis (S13), and the stored data is accumulated and analyzed once again by the machine learning and artificial intelligent framework in the future (S14). Such an analysis process may include simple extraction of change or the like in the sensor data per second, minute or hour according to the service domain. Alternatively, the sensor data generated in real time may be analyzed through a model (model serving) previously learned by a deep learning method utilizing the cloud server or the like. In this case, the served learning model may be periodically updated with a new model.

However, the intelligent computing node 120 according to one embodiment of the present invention is not reduced by only this function and may be expandable as the data is processed on the edge computing platform 100 by the service domain information in response to service requirements.

Unlike the initial raw data D1, the analyzed data D2 generated by the analysis process may be combined with additionally generated metadata. Further, the analyzed data (D2) may be subjected to a classification process S15, and then transmitted to the cloud server 20 (S16), temporarily stored (S17) or provided as an action command for the IoT device 107 (S18).

The data processing procedure shown in FIG. 4 refers to processes performed in the intelligent IoE information framework of the computing system 100 according to one embodiment of the present invention, which are applicable to smart healthcare, a smart building, a smart factory, etc.

[Application of Dynamic IoE Data Processing Model Using Cloud Model]

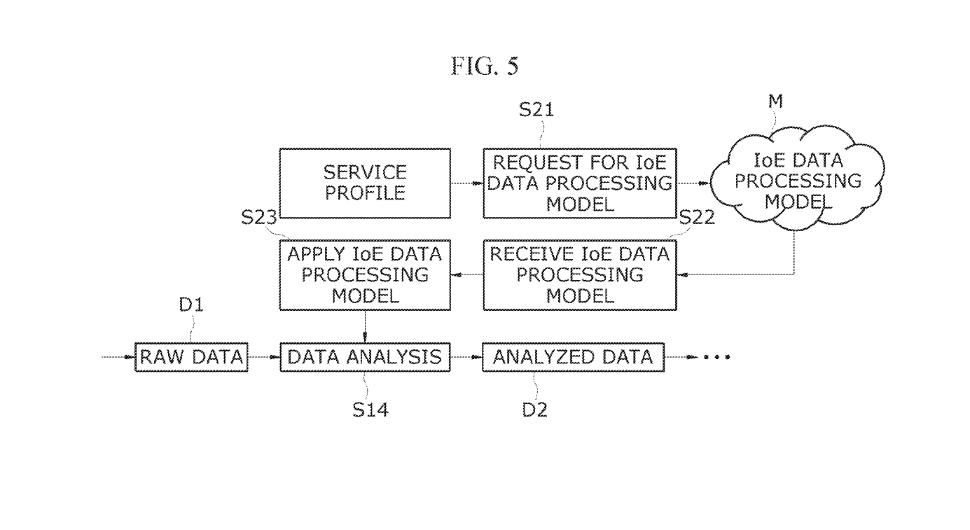

FIG. 5 is a view illustrating a procedure of using an IoE data analysis model provided through the cloud server 20.

The computing system 100 for the intelligent IoE information framework according to one embodiment of the present invention can analyze and process the raw data D1, which is generated in the intelligent computing node 120 real time, through its own artificial intelligent platform like that shown in FIG. 4. Besides, the intelligent computing node 120 may dynamically receive and execute an IoE data analysis model (M) specialized to the service domain provided by the cloud server 20 or the like.

Specifically, the intelligent computing node 120 according to one embodiment of the present invention may analyze a service profile or directly transmit the service profile to the cloud server 20 through the edge gateway node 130. In this case, the service profile may include the forms of input data and output data and contents for carrying out the operations of the IoT terminal 10.

That is, the intelligent computing node 120 may transmit a request/response message exchange of the IoE data processing model M corresponding to the service profile to the cloud server 20 through the edge gateway node 130 (S21), and the cloud server 20 receives the exchanged request/response message and finds and serves the optimum IoE data processing model M based on the service profile (S22).

The request/response message may be achieved in the form of a RESTful message exchange.

Meanwhile, the process of transmitting and receiving the IoE data processing model M may be achieved by the existing communication process, and the served IoE data processing model M may be carried out through the physical or virtualized intelligent computing node 120. Alternatively, the served IoE data processing model M may be carried out through a separate virtualized intelligent computing node 120.

After receiving and applying the served IoE data processing model M (S23), the process of analyzing the raw data D1 is equal to that of FIG. 4.

Like this, according to one embodiment of the present invention, the dynamic IoE data processing model M is received as shown in FIG. 5 to configure the intelligent computing node 120 using the virtualization technology for continuous execution, and the exchange may be carried out between the existing IoE data processing model and a new IoE data processing model.

That is, according to one embodiment of the present invention, a rotation model for changing the IoE data processing model M according to circumstances may be provided by not only utilizing the IoE data processing model M previously provided to be interworking with the cloud server 20, but also analyzing the periodically generated data through the reward/operator 160 according to the policy.

[Intelligent Information Networking Procedure]

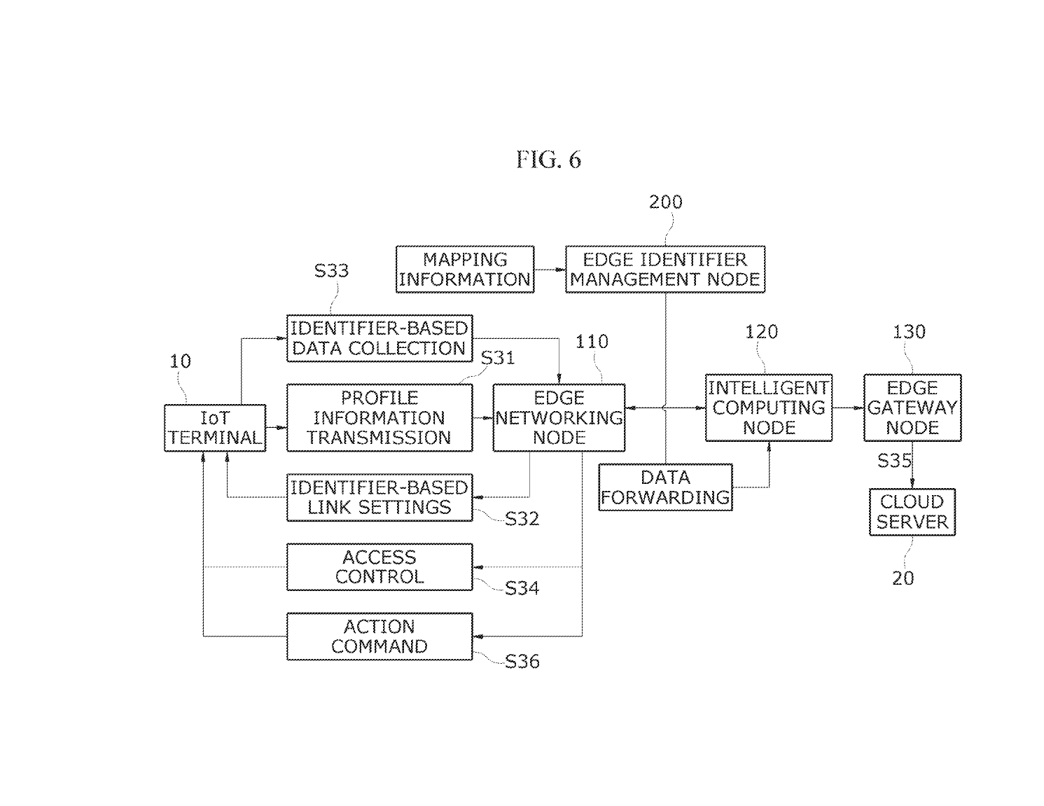

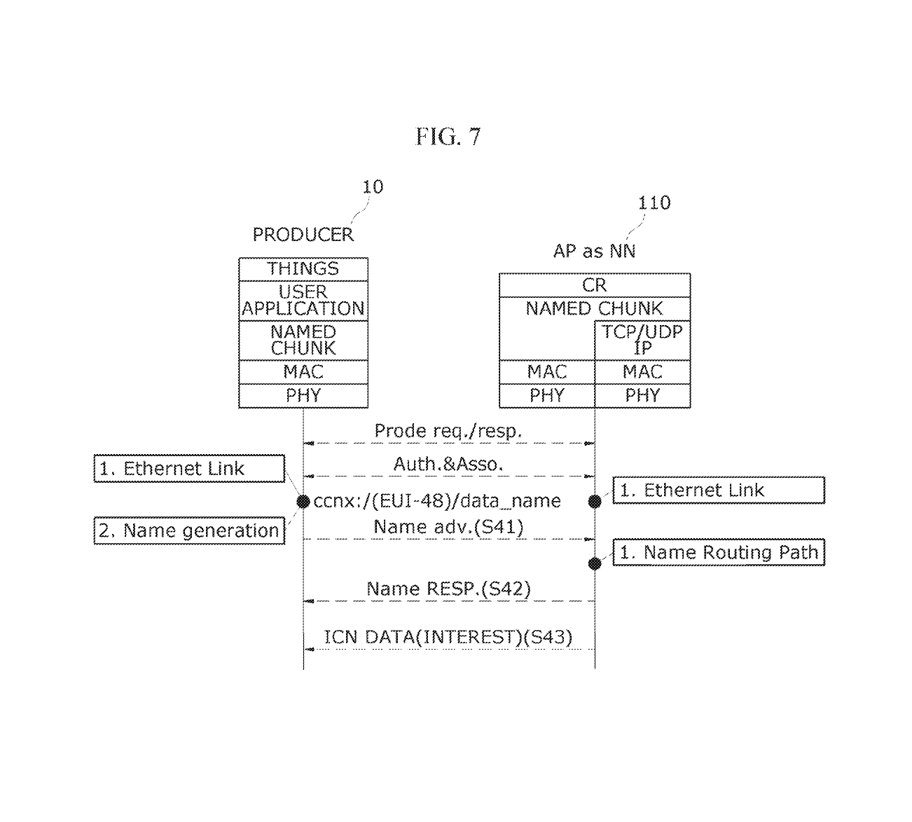

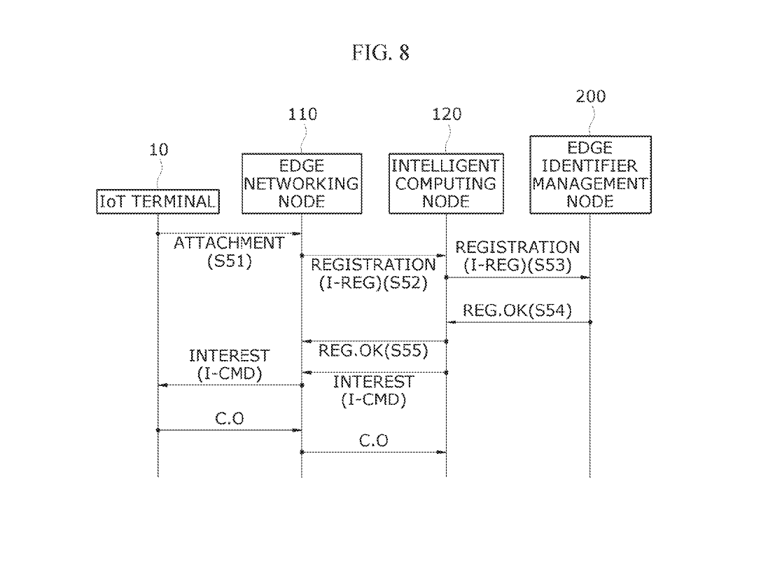

FIG. 6 is a view illustrating a procedure of supporting the intelligent IoT/IoE networking. FIG. 7 is a view illustrating a bootstrapping procedure between the IoT terminal 10 and the edge networking node 110. FIG. 8 is a view illustrating a bootstrapping procedure between the edge networking node 110 and the intelligent computing node 120.

First, to support the ICN-based connectivity between the IoT terminal 10 and the edge networking node 110, the IoT terminal 10 transmits its own profile to the edge networking node 110 (S31). In this case, the profile transmitted by the IoT terminal 10 may include the identifier of the IoT terminal 10 itself given in the form of the URI, the data identifier, the service type, etc.

Prior to this, in a case of directly using a Layer 2 technology, connection between the IoT terminal 10 and the edge computing node 110 may be set when the node is initially booted up. This procedure will be described later with reference to FIG. 7.

At the same time, the bootstrapping procedure as shown in FIG. 8 is performed for configurations between the edge computing node 110, the intelligent computing node 120, and the edge identifier management node 200. Through this procedure, it is possible to secure the ICN-based connectivity between the IoT terminal 10—the edge networking node 110—the intelligent computing node 120.

Then, the IoT data is collected in the intelligent computing node 120 by a simple single request (Interest)/response (Content Object) exchange message as a basic communication procedure of the ICN. In this case, according to one embodiment of the present invention, unlike the existing Internet, signature information for access privileges of the IoT terminal 10 and the data itself is generated instead of exchanging a security message for a communication channel, such as TLS, DTLS, etc. and thus it is possible to check validity while freely transmitting and receiving the data (S32, S33).

Further, the edge networking node 110 generates the signature information of the IoT terminal 10 connected thereto on the basis of a public-key and performs an access control function on the basis of the signature information (S34).

In this case, the IoT terminal 10 is constrained from direct security computing, and therefore the edge computing node 110 serves as proxy in a case of access control. Therefore, the edge computing node 110 can separately generate and manage the signature information of the IoT terminal 10 by using the identifier of each IoT terminal 10 as a seed value and utilizing the public-key.

The data collected through the intelligent computing node 120 is transmitted to the cloud server 20 through the foregoing data processing procedure, or the action command is transmitted again to the IoT terminal 10. In this case, the edge gateway node 130 functions to transmit the data to the cloud server 20 on the Internet (S35), and the edge networking node 110 serves to transmit the identifier-based action command again to the IoT terminal 10 (S36).

Meanwhile, the bootstrapping procedure for the identifier-based connection between the IoT terminal 10 and the edge networking node 110, and the bootstrapping procedure between the edge networking node 110 and the intelligent computing node 120 are as shown in FIG. 7 and FIG. 8, respectively.

Both the IoT terminal 10 and the edge computing node 120 basically employ the identifier-based communication (ICN technology), and therefore each node needs an ICN stack. Further, it is necessary to allocate the identifier between the nodes by the function for setting and generating the identifier.

In general, the bootstrapping procedure uses a hierarchical identifier together with the URI, and the IoT terminal 10 that generates data informs the edge networking node 110 of its own identifier and the identifier of the data by transmitting and receiving identifier information (advertisement/response). With this, a network internal node, such as the edge networking node 110 or the intelligent computing node 120, may transmit a request (Interest) message to the IoT terminal 10 that generates the data.

FIG. 7 illustrates the procedures of connection and identifier allocation between the IoT terminal 10 that generates the data and the edge networking node 110 through an IEEE 802.11 Wi-Fi network.

The IoT terminal 10 automatically generates the identifier of the data generated together with a value obtained by hashing EUI-48 data based on its own Ethernet MAC address and transmits an identifier notification message (Name Advertisement) to the edge networking node 110 (S41).

The edge networking node (110, equivalent to the AP in FIG. 7) receives the identifier notification message, registers the identifier of the IoT terminal 10, updates a routing path for transmitting and receiving the data, and then transmits a response message to the IoT terminal 10 (S42).

Then, the edge networking node 110 uses the identifier of the IoT terminal 10 to request the data (Interest) (S43).

FIG. 8 illustrates a procedure of supporting connection between the edge networking node 110 and the intelligent computing node 120 on the intelligent IoE information framework according to one embodiment of the present invention.

As described above with reference to FIG. 7, the edge networking node 110 can receive the identifier of the IoT terminal 10 (S51, attachment process) through the bootstrapping procedure between the IoT terminal 10 and the edge networking node 110.

Then, the edge networking node 110 registers the identifier of the IoT terminal 10 as the intelligent computing node 120 on its own edge computing platform 100 (S52, registration process). Through the registration process, the intelligent computing node 120 obtains information about the IoT terminal 10 and information about the data which are present in its own domain.

Then, the intelligent computing node 120 registers the identifier of the IoT terminal 10 for which it is responsible and its own identifier to the edge identifier management node 200 and maintains the mapping information (S53). This information may be used in the future to support a seamless handover of data when the IoT terminal 10 is moving.

As the registration is completed, the edge identifier management node 200 transmits a response message to the intelligent computing node 120, and the intelligent computing node 120 transmits a response message to the edge networking node 110 (S54, S55).

The following procedures will be described later in detail with regard to descriptions about the mobility.

[Data Collection and Use in IoT Terminal]

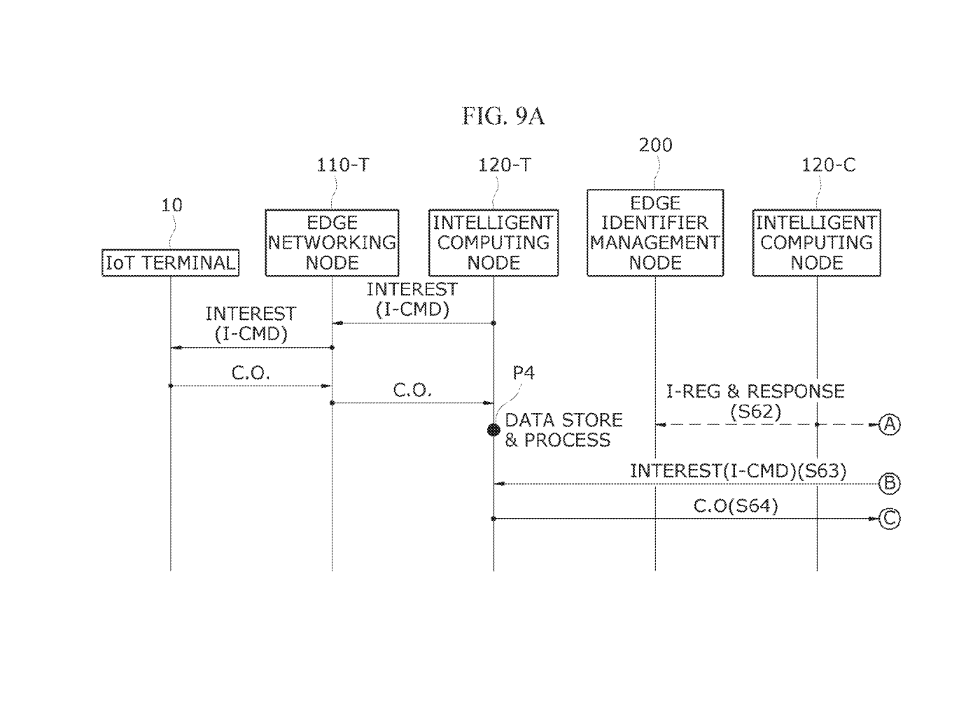

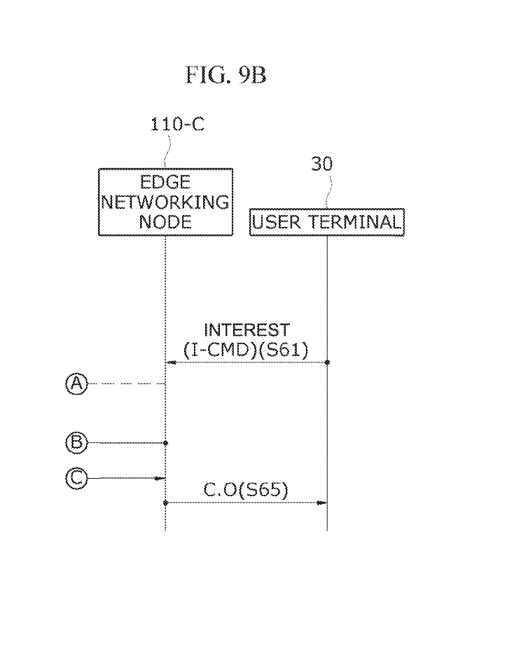

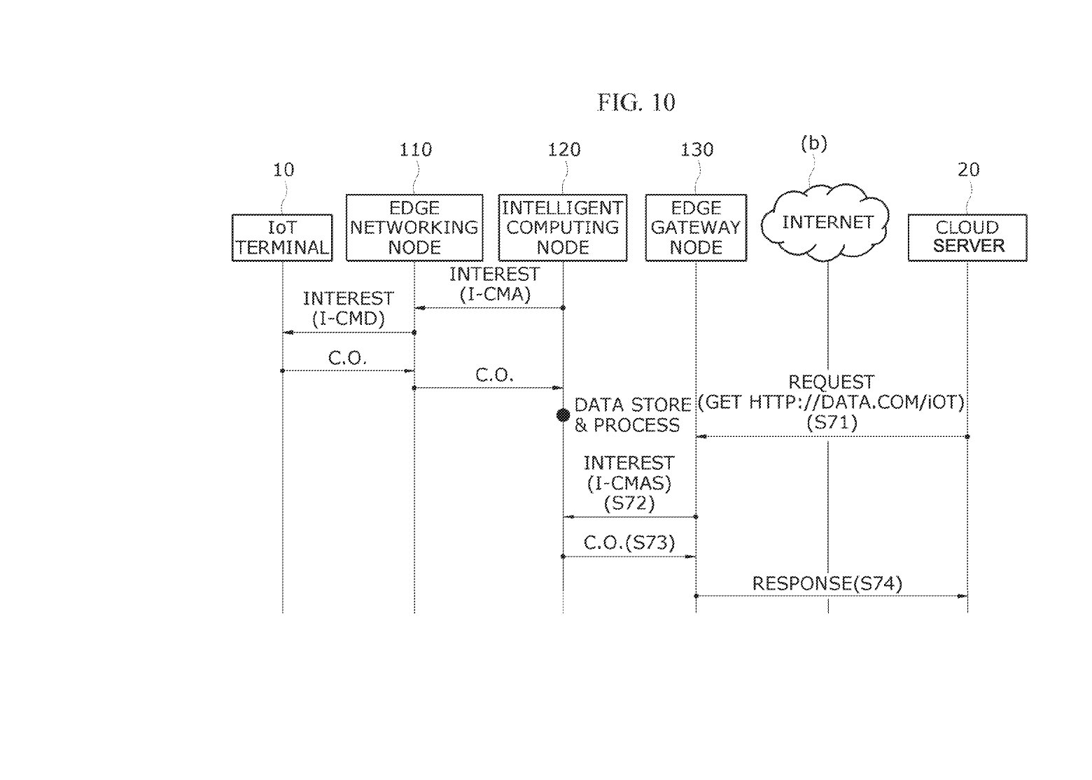

Below, a procedure of acquiring the data of the IoT terminal 10 by the user terminal 30 located within the edge computing platform 100 and the cloud server 20 located at the outside will be described with reference to FIGS. 9A and 10.

FIG. 9A and FIG. 9B are a view illustrating a procedure of acquiring the data of the IoT terminal 10 by the user terminal 30.

According to one embodiment of the present invention, unlike a general IoT terminal-cloud server model or a typical ICN model, it is possible to provide the data through the edge computing platform 100. Meanwhile, the user terminal 30 may refer to a general user, but may refer to an edge computing platform 100 located on another domain according to circumstances.

Thus, according to one embodiment of the present invention, an IoT terminal edge computing platform 100-T for generating data with respect to the IoT terminal 10 and a user terminal edge computing platform 100-C for consuming the data with respect to the user terminal 30 may be positioned as shown in FIG. 9A and FIG. 9B.

In this case, an intelligent computing node 120-C may be asymmetrically operated to not work much within the user terminal edge computing platform 100-C. The intelligent computing node 120-C within the user terminal edge computing platform 100-C may be used for supporting the seamless handover while the user terminal 30 is moving, and this will be described later in a part for describing the mobility.

The data of the IoT terminals 10, which generate the data by the foregoing networking settings of FIGS. 7 and 8, is stacked in the intelligent computing node 120-T on the IoT terminal edge computing platform 100-T (P4).

When the user terminal 30 transmits a request message (Interest) for the data to an edge networking node 110-C of the user terminal edge computing platform 100-C in order to acquire the data of the IoT terminal 10 (S61), the edge networking node 110-C receives the request message (Interest).

Next, the edge networking node 110-C determines the request message (Interest) and transmits a control message for inquiring about the identifier to the edge identifier management node 200 (S62). By this procedure, the edge networking node 110-C receives the identifier of the intelligent computing node 120-T of the IoT terminal edge computing platform 100-T, in which the data generated by the IoT terminal 10 is stored, from the edge identifier management node 200 through the intelligent computing node 120-C.

Then, the user terminal edge computing node 110-C transmits a message (Interest) for requesting the data of the IoT terminal 10 and the analyzed data to the intelligent computing node 120-T of the IoT terminal edge computing platform 100-T on the basis of the identifier information (S63). Then, the intelligent computing node 120-T that receives the message transmits the corresponding data to the edge networking node 110-C(Content Object, S64), and finally the edge networking node 110-C transmits the corresponding data to the user terminal 30 (Content Object, S64).

Meanwhile, although it is not illustrated in FIG. 9A and FIG. 9B, the transmission/reception of the message or data between the IoT terminal edge computing platform 100-T and the user terminal edge computing platform 100-C is performed via edge gateway nodes 130-T and 130-C respectively provided included in the edge computing platforms 100-T and 100-C. On the other hand, the message or data can be directly transmitted and received between the nodes 110-C, T, 120-C, T, 130-C, and T of the edge computing platforms 100-T and 100-C and the edge identifier management node 200.

FIG. 10 is a view illustrating a procedure of acquiring the data of the IoT terminal 10 by the external cloud server 20, i.e. a view for describing an interoperability supporting procedure for acquiring the data of the IoT terminal 10 on the edge computing platform 100 on the basis of the ICN-based edge computing platform 100 using the cloud server 20 present on the general Internet.

First, the cloud server 20 on the Internet (b) generally transmits a request message for acquiring the data based on an HTTP standard message to the edge gateway node 130 through a web or a similar RESTful API (S71). This message is to acquire an IP address on the edge computing platform 100, in which the IoT terminal is present, through a domain name server (DNS) service as in a general Internet scenario.

In this case, the IP address to be acquired is the IP address of the edge gateway node 130 responsible for interworking with the IP Internet on the edge computing platform 100, and therefore the request message is transmitted to the edge gateway node 130.

The edge gateway node 130 analyzes and converts the received request message into an ICN-based message (Interest) and transmits the converted message to the intelligent computing node 120 (S72).

Next, the edge gateway node 130 receives one or more of the data of the IoT terminal 10 and the analyzed data of the corresponding data from the intelligent computing node 120 (S73, Content Object), and the data is configured as a web-standard message through an Internet protocol networking-based conversion procedure and transmitted to the cloud server 20 (S74, Response).

Meanwhile, according to one embodiment of the present invention, a header format conversion module may be provided to interwork the ICN with Internet for the forgoing procedure and serves as proxy for HTTP to ICN.

[Support of Various Types of Mobility]

The computing system 1 for the intelligent IoE information framework according to one embodiment of the present invention supports ICN-type mobility unlike the publicly known mobility support technology in the IP-based Internet

That is, according to one embodiment of the present invention, a structure for focusing on data itself and acquiring the data while the terminal is moving is proposed, rather than the end-to-end state conservation techniques—the existing mobility IP, proxy mobile IP, etc. for directly managing and controlling position information of the IoT terminal 10, the user terminal 30 and a similar terminal or the communication end.

Thus, according to one embodiment of the present invention, there is no need to manage the end-to-end state, and management is performed whenever data is requested, thereby supporting stateless mobility. In particular, in terms of the ICN, it is possible to support the mobility of the user terminal 30, the mobility of the IoT terminal 10, and the mobility of data where storage for the data is altered, and respective detailed descriptions thereof will be made below.

Procedure of Supporting Mobility of User Terminal

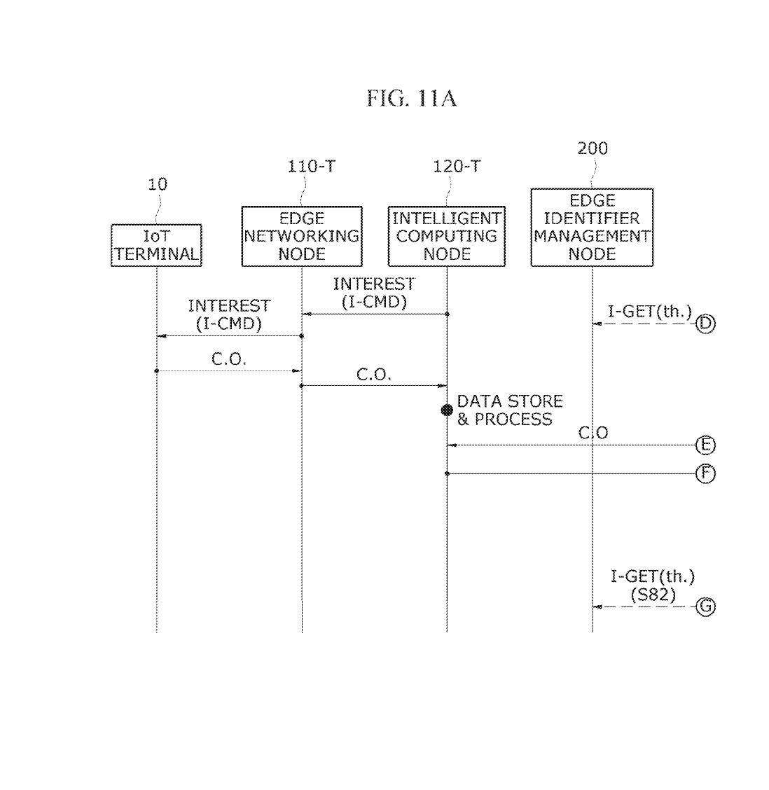

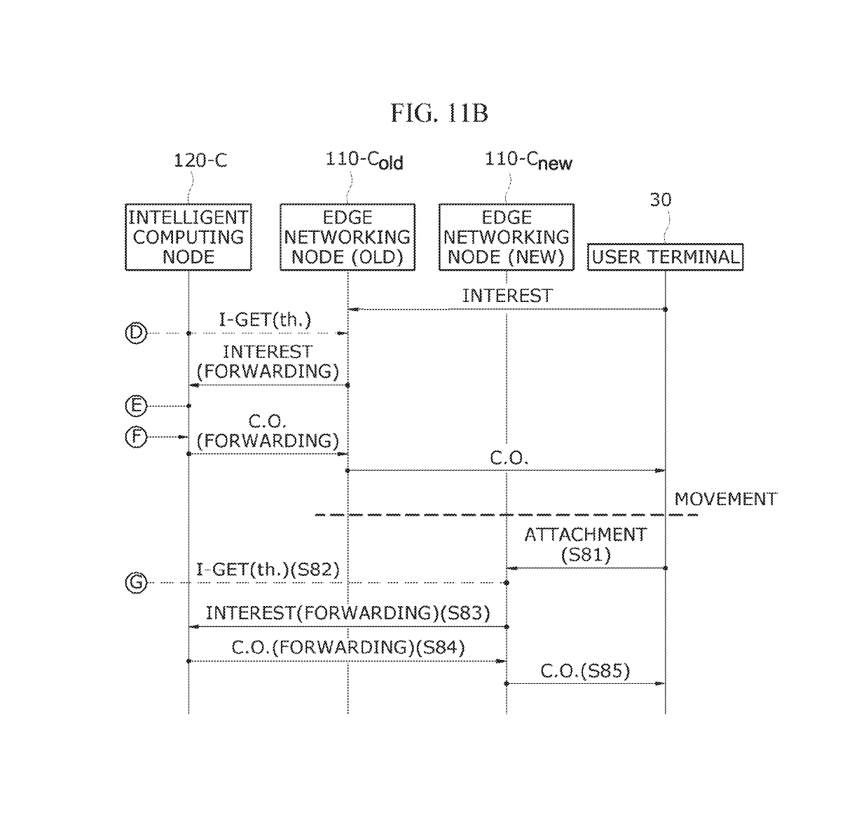

FIG. 11A and FIG. 11B are a view illustrating a procedure of supporting the mobility of the user terminal 30 and a procedure of supporting a seamless handover.

To continuously acquire data while the user terminal 30 is moving, according to one embodiment of the present invention, it is possible to simply support the mobility in the form of a PULL type through the existing ICN request/response (Interest/Content Object) message.

That is, while the user terminal 30 is moving, the user terminal 30 first performs a procedure for connection settings (Attachment), and then immediately transmits the request message (Interest) once again, thereby supporting the mobility.

However, when the user terminal 30 moves out of an edge computing platform (100-C_{Old}) to the edge computing platform 100-C_{new} corresponding to a new domain, the user terminal 30 has to perform a procedure of newly registering its own identifier to the edge identifier management node 200 and the edge networking node 110-C_{new} on the edge computing platform 100-C_{new} as shown in FIGS. 7 and 8. With this, according to one embodiment of the present invention, the user terminal 30 can check validity and receive data through an intelligent computing node 120-C_{new} of the edge computing platform 100-C_{new} where the user terminal 30 is located.

Meanwhile, according to one embodiment of the present invention, the operation of the intelligent computing node may be performed as shown in FIG. 11A and FIG. 11B to support the seamless handover.

As shown in FIG. 9A and FIG. 9B, the user terminal 30 is generally capable of acquiring the data directly through the edge networking node 110-C by making the intelligent computing node 120-C of the user terminal edge computing platform 100-C enter a transparency mode.

However, for the seamless handover, a resolution message (Interest-get message) toward the edge identifier management node 200 is set to bypass the intelligent computing node 120-C, and then a forwarding option is added to the edge networking node 110-C so that a request message (Interest) for acquiring the data can be also transmitted through the intelligent computing node 120-C. Thus, the data from the intelligent computing node 100-T at the IoT terminal generating the data is continuously stacked on the intelligent computing node 100-C at the user terminal.

Therefore, when the user terminal 30 connecting with the first edge networking node 110-C_{old} within the edge computing platform 100-C moves to connect with the new second edge networking node 110-C_{new} within the edge computing platform 100-C(S81), the second edge networking node 110-C_{new} transmits a resolution message (I-get(th.) to the edge identifier management node 200 after the existing registration procedure and receives identifier information of the intelligent computing node 120-C(S82).

Then, the second edge networking node 110-C_{new} transmits the data of the IoT terminal 10 or the request message (Interest(forwarding)) to obtain the analyzed data to the intelligent computing node 120-C on the basis of the identifier information of the intelligent computing node 120-C(S83) so that the continuously stacked data of the IoT terminal 10 can be directly returned through the intelligent computing node 120-C(S84, Content Object(Forwarding)) and provided to the user terminal 30 (S85).

Like this, according to one embodiment of the present invention, the seamless handover of the data is naturally supported by the data forwarding procedure even when the data is likely to be lost while the user terminal 30 is moving to connect with the new edge networking node 110-C_{new}.

Procedure of Supporting Mobility of IoT Terminal

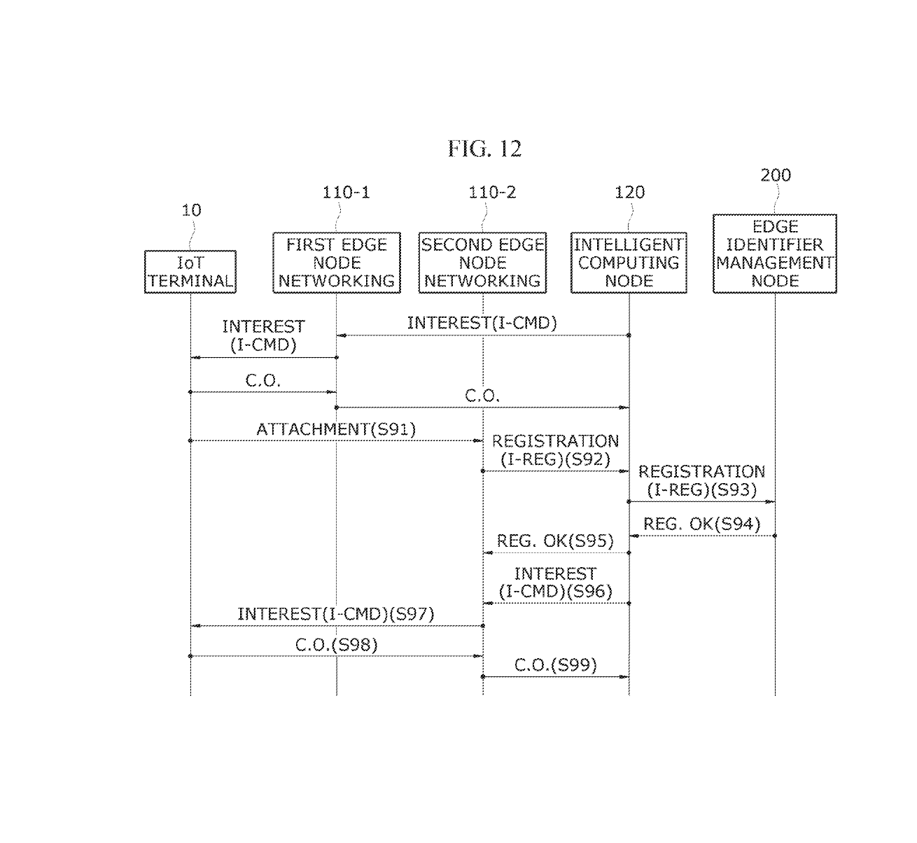

FIG. 12 is a view illustrating a procedure of supporting the mobility of the IoT terminal 10 on the edge computing platform 100.

In general, in a case of the ICN, the mobility of the IoT terminal is not naturally supported. On the other hand, the computing system 1 for the intelligent IoE information framework according to one embodiment of the present invention is capable of supporting the mobility of the IoT terminal 10 through the intelligent computing node 120.

Referring to FIG. 12, first, when the IoT terminal 10 connecting with a first edge networking node 110-1 moves to connect with a second edge networking node 110-2 within the edge computing platform 100 (S91), the second edge networking node 110-2 performs a registration procedure with regard to the new IoT terminal 10.

That is, the second edge networking node 110-2 registers the IoT terminal 10 to the intelligent computing node 120, and then the intelligent computing node 120 registers the IoT terminal 10 to the edge identifier management node 200 (S92˜S5).

As the registration procedures are completed, the intelligent computing node 120 transmits a message (Interest) to the second edge networking node 110-2 currently connecting with the IoT terminal 10 to request the data of the IoT terminal 10, and thus acquires the requested data from the IoT terminal 10 (S96˜S99).

Further, the edge identifier management node 200 may generate mapping information, in which the identifier information of the IoT terminal 10 and the identifier information of the intelligent computing node 120 are mapped with each other so as to process a request in the future when the user terminal 10 makes the request for the data of the IoT terminal 10. Thus, the user terminal 30 can route identifier-notification (name-aware) to the intelligent computing node 120 in order to naturally acquire the data generated in the IoT terminal 10 though the edge identifier management node 200.

Procedure of Supporting Mobility of Data

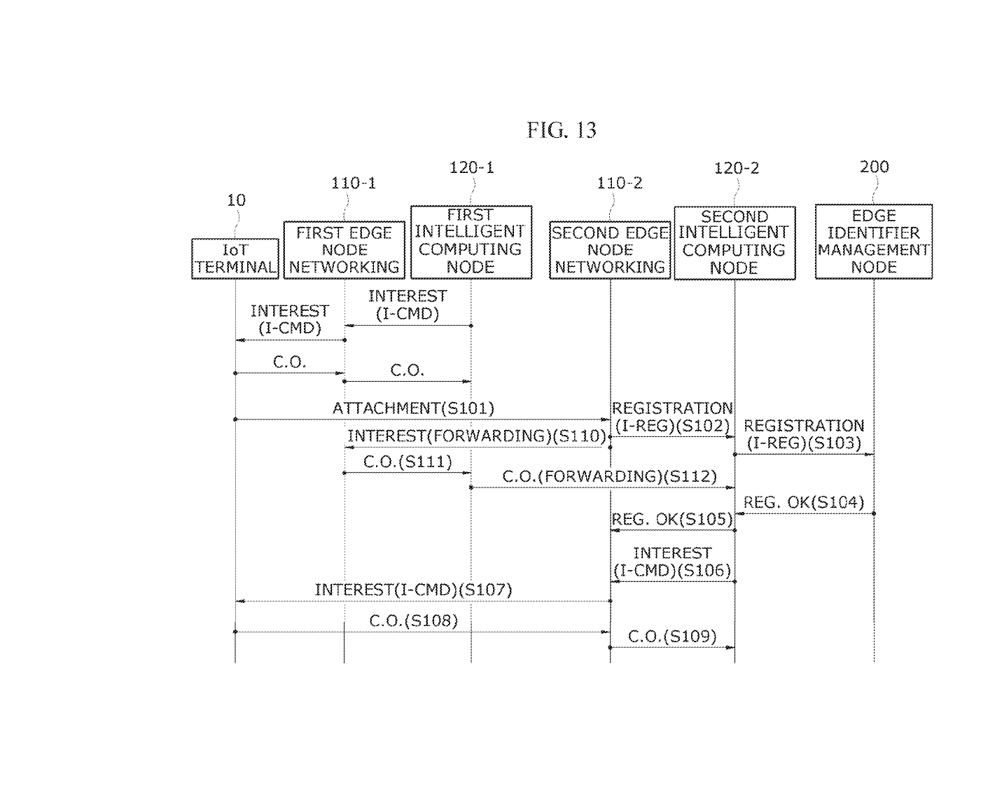

FIG. 13 is a view illustrating a data mobility supporting procedure and a seamless handover procedure between a plurality of edge computing platforms 100-1 and 100-2.

While the IoT terminal 10 moves between the domains corresponding to the edge computing platforms 100-1 and 100-2, there are the mobility of the IoT terminal 10 for generating the data and the mobility of the data where the intelligent computing node 120 for storing the data is switched over.

Like this, according to one embodiment of the present invention, it is possible to support such mobility even when the IoT terminal 10 moves from the first edge computing platform 100-1 to the second edge computing platform 100-2.

First, as the IoT terminal 10 moves from the first edge computing platform 100-1 to the second edge computing platform 100-2, the edge networking nodes 110-1 and 110-2 are switched over, and the intelligent computing node 120-1 is also switched over to the node 120-2 within the second edge computing platform 100-2 (S101).

When the IoT terminal 10 moves to the second edge computing platform 100-2, the edge networking node 110-2 of the second edge computing platform 100-2 informs the intelligent computing node 120-2 that, through a registration procedure, the IoT terminal 10 moves to a new domain (S102).

Further, the intelligent computing node 120-2 registers the IoT terminal 10 to the edge identifier management node 200 (S103, S104). During this procedure, the intelligent computing node 120-2 transmits the identifier information of the IoT terminal 10 and its own identifier information to the edge identifier management node 200, and the edge identifier management node 200 generates and manages mapping information by mapping the identifier of the IoT terminal 10.

When such registration procedures are completed (S105), the intelligent computing node 120-2 of the second edge computing platform 100-2 transmits a request message (Interest) to the edge networking node 110-2 in order to collect the data of the IoT terminal 10 (S106).

When the request message is transmitted to the IoT terminal 10 through the edge networking node 110-2 (S107), the IoT terminal 10 provides the requested data to the intelligent computing node 120-2 (S108) through the edge networking node 110-2 of the second edge computing platform 100-2 (S108) so that the data of the IoT terminal 10 moved to the new domain can be stored in a new intelligent computing node 120-2.

Further, when it is necessary for the user terminal 30 to acquire the data of the IoT terminal 10 moved to the new domain, the user terminal 30 receives the identifier of the new intelligent computing node 120-2 through the edge identifier management node 200 and acquires the corresponding data.

Meanwhile, in a case of the mobility between the domains as shown in FIG. 13, it is impossible to use the data of the IoT terminal 10 which has been stored in the intelligent computing node 120-1 of the existing first edge computing platform 100-1.

To support the seamless handover under this condition, according to one embodiment of the present invention, the edge networking node 110-2 of the second edge computing platform 100-2 makes a forwarding request to the edge networking node 110-1 of the first edge computing platform 100-1 simultaneously with or separately from the foregoing registration procedure (S110).

In response to this request, one or more of the data of the IoT terminal 10 and the analyzed data, which are stored in the intelligent computing node 120-1 of the first edge computing platform 100-1, may be forwarded to the intelligent computing node 120-2 of the second edge computing platform 100-2 (S111, S112), and it is thus possible to effectively support the seamless handover while the data is moving.

For reference, the elements shown in FIG. 1 according to an embodiment of the present invention may be materialized by software or hardware such as a field programmable gate array (FPGA) or an application specific integrated circuit (ASIC) to implement predetermined functions.

However, the ‘elements’ are not limited to the software or hardware, but may be configured to be present in an addressable storage medium or to reproduce one or more processors.

Therefore, for example, the elements include software elements, object-oriented software elements, class elements, task elements, and similar elements, processes, functions, attributes, procedures, subroutines, segments of a program code, drivers, firmware, microcode, circuits, data, database, data structures, tables, arrays, and variables.

The elements and the functions provided in the elements may be combined into fewer elements or divided into more elements.

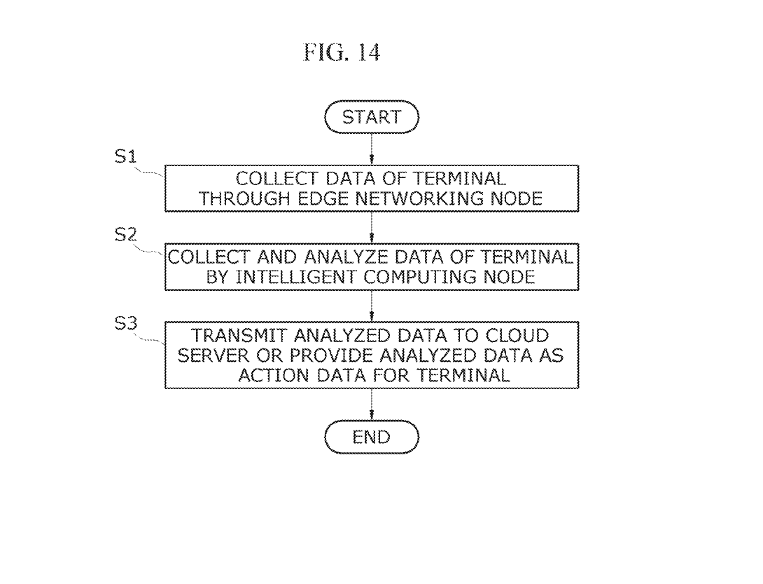

Below, a computing method for the intelligent IoE information framework according to one embodiment of the present invention will be described with reference to FIG. 14.

FIG. 14 is a flowchart of the computing method for the intelligent IoE information framework.

First, data of a terminal is received through an edge networking node that supports connectivity with the terminal (S1).

Next, an intelligent computing node collects and analyzes the data of the terminal (S2), and the analyzed data is transmitted to a cloud server through an edge gateway node, or provided as operation data for the terminal through the intelligent computing node (S3).

In the foregoing description, the operations S1 to S3 may be divided into more operations or combined into fewer operations according to embodiments of the present invention. Further, some operations may be omitted or reordered as necessary and the order thereof may be changed. In addition, the features of the computing system 1 described with reference to 1 FIGS. 1 to 13 are also applied to the computing method of FIG. 14.

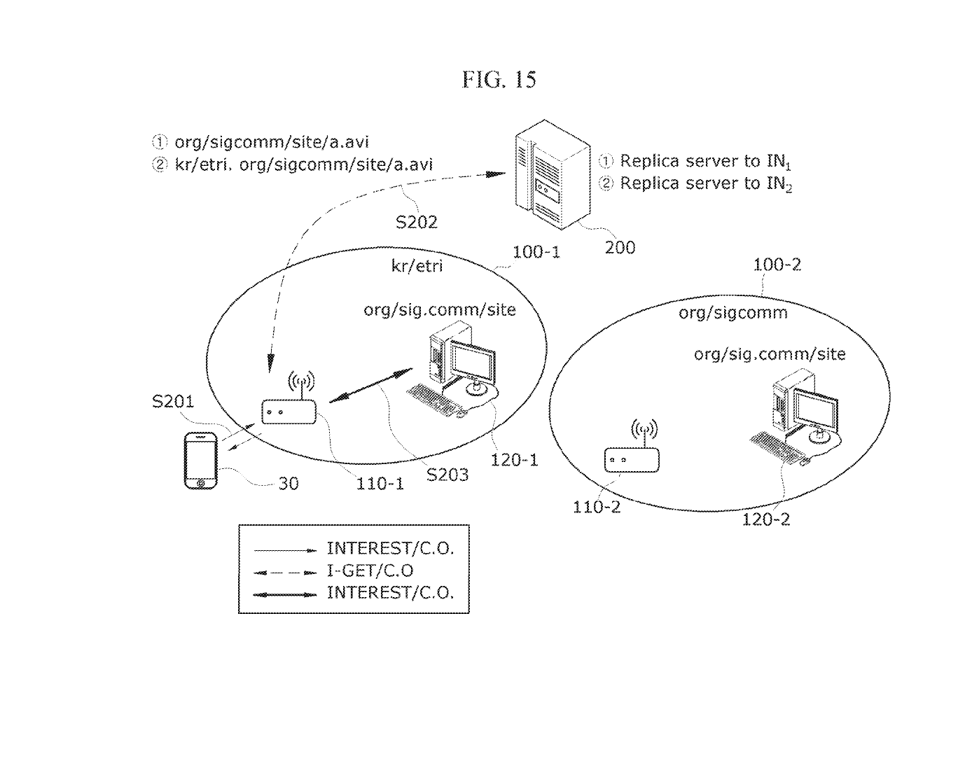

Below, embodiments to which the computing system 1 and method for the intelligent IoE information framework are applied will be described with reference to FIGS. 15 to 19.

### EMBODIMENTS

### 1. Information Replication Service Between Intelligent Information Platforms

FIG. 15 is a view illustrating a data processing scenario in two edge computing domains 100-1 and 100-2 including the same data.

Among pieces of IoE information, some pieces of information should be rapidly responded to or provided with like media generated by a closed circuit television (CCTV) in real time or personally generated media.

In this case, as shown in FIG. 15, there may be present edge networking nodes 110-1 and 110-2 proactively retaining storage media between the edge computing domains 100-1 and 100-2 and supporting this shared information and networking. Meanwhile, descriptions about information replication procedures and methods for jointly retaining the same information will be omitted in the disclosure of the present invention.

Under the condition that the same information is retained, the intelligent computing nodes 120-1 and 120-2 according to one embodiment of the present invention are capable of registering that the same data is present in the edge computing platforms 100-1 and 100-2 corresponding to the two domains through a registration procedure for identifier mapping with the edge identifier management node 200.

In such circumstances, to obtain the closest information, the user terminal 30 first transmits a request message (Interest) to the network, as in a method of acquiring general data (S201).

Then, the edge networking node 110-1 on the edge computing platform 100-1 can obtain two pieces of edge computing platform information (intelligent computing node information—uniform resource locator (URL)), which has target data, through the edge identifier management node 200 (S202).

According to one embodiment of the present invention, an identifier part includes networking part information, and therefore the edge networking node 110-1 receiving a request message can select the closest intelligent computing node 120-1 and rapidly acquire data through the closest intelligent computing node 120-1.

### 2. Privacy Support Service in Smart Healthcare System

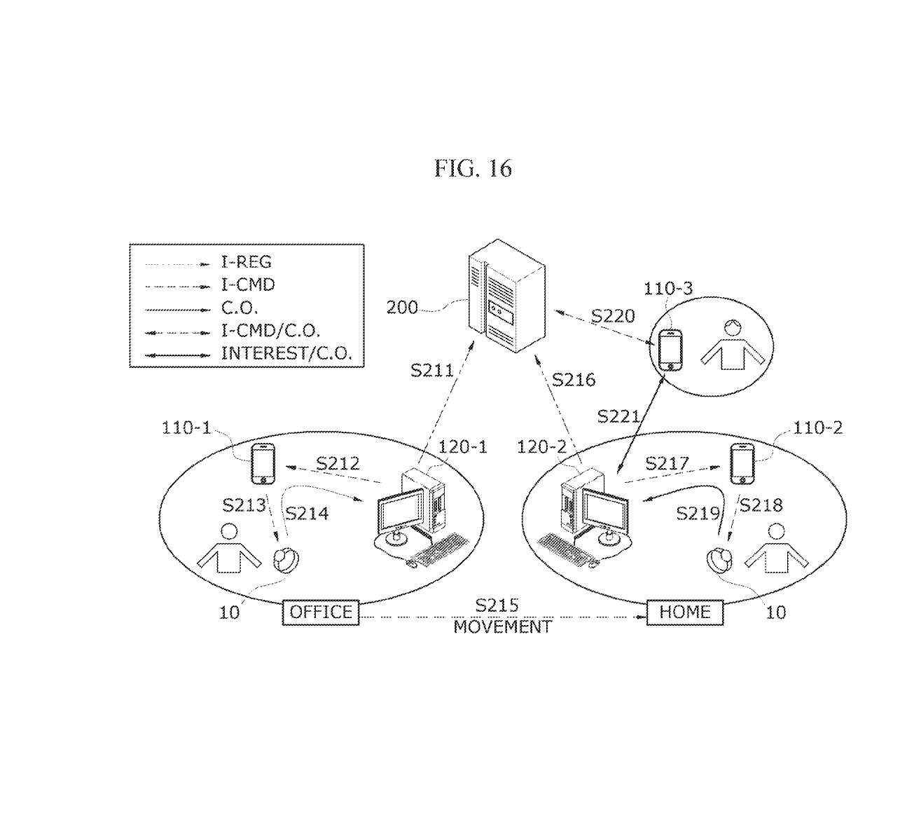

FIG. 16 is a view illustrating a privacy guarantee service supported in a smart healthcare system.

FIG. 16 shows that a user is wearing a smart health device 10 for measuring his own biometric information. However, data generated in such a smart health device 10 involves private information and is therefore likely to raise privacy concerns when the data is uploaded to a public cloud server or a cloud server of a service user.

Therefore, the edge computing platform 100 according to one embodiment of the present invention may be mounted to and driven in a Raspberry Pi or a similar computer that restrictedly includes a CPU and a memory.

Thus, a user is allowed to store the data in a private storage installed and managed only by himself/herself using a smartphone at home or office or while being on the move.

Further, the data, which is previously processed to be unidentifiable and free from privacy concerns, is uploaded to the cloud server 20, and an ordinary smart healthcare service is possible.

For example, in a state that the intelligent computing node 120-1 at the office has been already registered to the edge identifier management node 200 (S211), the intelligent computing node 120-1 can use a user's smartphone as the edge networking node 110-1 to receive the data of a smart health device 10 (S212˜S214). Thereafter, when the user moves from the office to home (S215), registration procedures are performed with the intelligent computing node 120-2 on the customer premise and the edge identifier management node 200 (S216), and then the user can use his/her smartphone 110-2 to receive data of the smart health device 10 (S217˜S219).

In this case, a smart health service provider determines movement of the smart health device 10 from the office to the home by performing the registration procedure with the edge identifier management node 200 (S220), and receives the data of the smart health device 10 by acquiring the identifier of the intelligent computing node 120-2 on the customer premise (S221).

Thus, the computing system 1 and method for the intelligent IoE information framework according to one embodiment of the present invention allow a user to generate a platform available on his/her domain everywhere and use a service though the edge identifier management node 200 registering and supporting the platform, thereby not only readily protecting privacy but also providing the existing services.

### 3. Smart Plant (Piping Information Process)

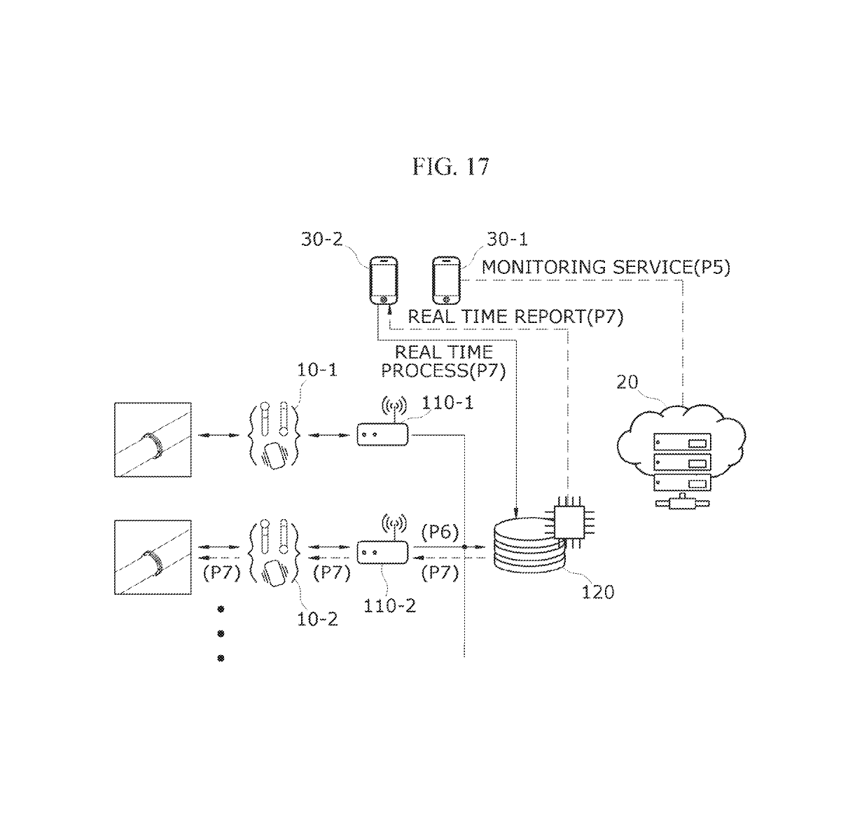

FIG. 17 is a view illustrating a procedure (P7) of supporting an urgent message process in a smart factory system.

As shown in FIG. 17, many sensors are currently used for monitoring (P5) safety for the purpose of a safety service in the piping or the like of an automated factory or a nuclear power plant.

However, data continuously generated in such monitoring is stored and analyzed in the cloud server 20, and therefore the cloud server 20 may cause a transmission delay, an analysis delay and a notification delay when a problem arises. Therefore, this model is not suitable for a time-critical system that requires processing in real time.

On the other hand, according to one embodiment of the present invention, the intelligent computing node 120 can directly analyze and monitor data, which is received in real time from each piping of the factory and the plant (P6).

Further, when a pattern different from the existing pattern is generated, a notification is directly provided to all user terminals 30-1 and 30-2 or a specific user terminal 30-2 without passing through the cloud server 20, thereby having advantages in terms of time.

Further, it is also possible to immediately test the security of the piping and directly support on/off control for a process through a reward system that supports an actual action command (P7).

In particular, according to one embodiment of the present invention, it is possible to get information through a simple message, and it is very useful in a time-critical situation.

### 4. Transmission Path Bypassing Support for Processing Data Through Multiple Mobile Terminals

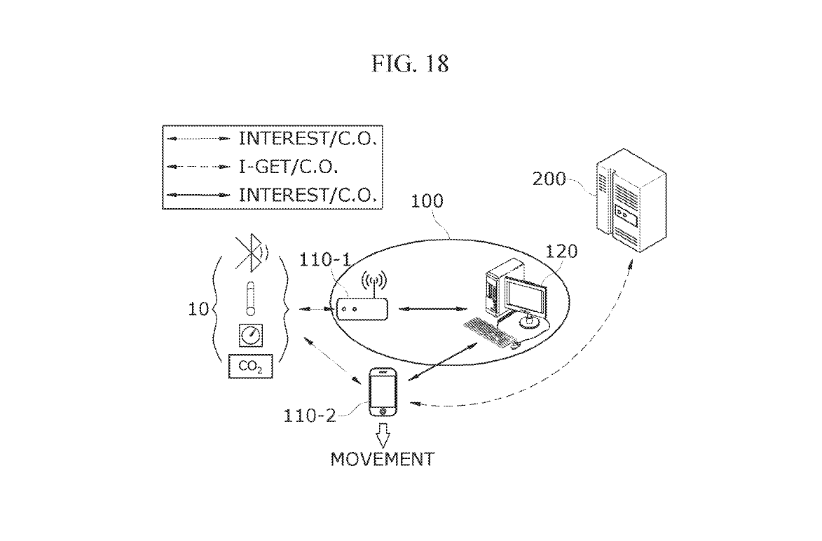

FIG. 18 is a view illustrating a procedure of supporting a data path bypassing process using a mobile terminal 110-2.

As the volume of data generated in the IoT terminal 10 gradually increases, the edge network node 110 on the edge computing platform 100 may still have problems of expandability and the like for processing a lot of data from 10¹⁰ IoT terminals 10 and providing the connectivity.

In particular, in a case of data generated in real time, a very serious problem may be caused in analyzing the data when the data is lost according to circumstance.

Therefore, according to one embodiment of the present invention, as shown in FIG. 18, the edge networking node 110-1 of the edge computing platform 100 may be expanded and developed as a smartphone 110-2 which many people carry.

Thus, according to one embodiment of the present invention, a path linked to the storage of the edge computing platform 100 may be diversified. Further, the smartphone 110-2 which many users carry can take part in collecting the data generated in the IoT terminal 10, thereby solving problems in expandable connectivity, data loss, etc.

Further, according to one embodiment of the present invention, the path is diversified to distribute data toward respective storages, and thus the problem of the expandability for the process in the intelligent computing node 120 is also solved.

In addition, according to one embodiment of the present invention, new intelligent computing nodes are dynamically generated according to the load of the intelligent computing node 120 used as the storage so that the intelligent information processing manager 140, the edge networking node 110-2, and the edge identifier management node 200 capable of storing the data can be used for supporting the transmission path bypass.

### 5. Support of Machine Learning Model Generation by Sorting and Combining Data

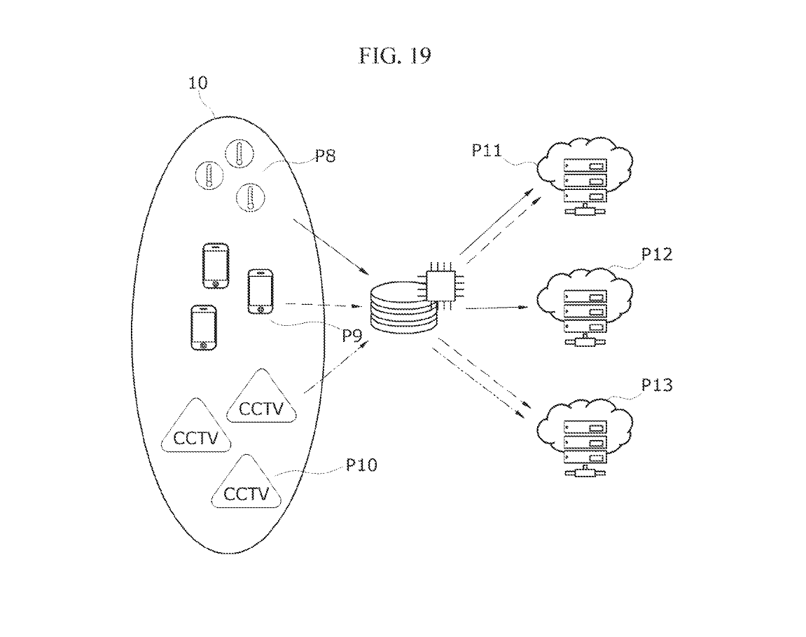

FIG. 19 is a view illustrating a procedure of supporting generation of a machine learning model by sorting and combining data.

According to one embodiment of the present invention, pieces of data P8˜P10 provided from various IoT terminals 10 are sorted and combined to thereby provide data for generating a machine learning model required for various IoT services P11˜P13, for example, for processing a traffic signal or operating a nuclear power plant.

First, the computing system 1 for the intelligent IoE information framework according to one embodiment of the present invention is used to learn a pattern and flow of data P8˜P10 generated from the IoT terminals 10.

Through such a learning procedure, sorted data is combined and transmitted to the servers P11˜P13 that are actually located in a central cloud server or the like and generate the machine learning model for providing IoT specific services.

For example, not only the data from the sensor but also additional data sensed by surrounding smartphones at that time are time-synchronized and provided to be used as data for making a machine learning model to recognize a dangerous situation in the factory.

Such a procedure provides not real-time data but previously-labeled data to thereby support a function of directly generating data used in making a service model through supervisory learning.

### 6. Configuration of Virtualization-Based Intelligent IoE Information Framework

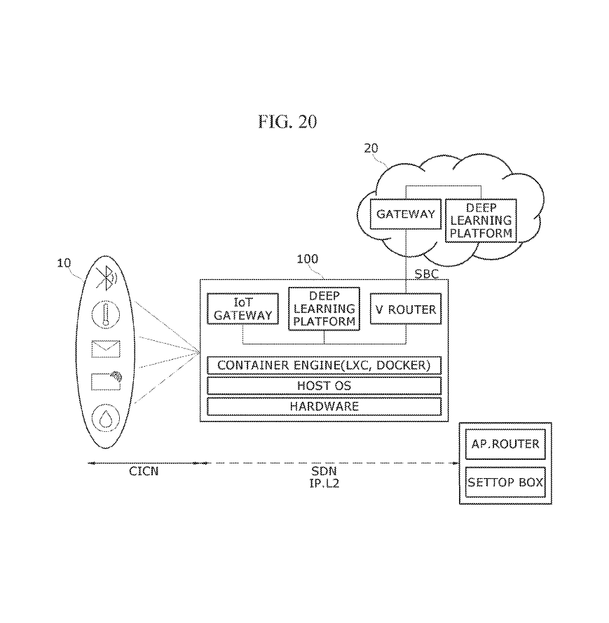

FIG. 20 is a view illustrating a platform 100 and framework based on virtualization.

According to one embodiment of the present invention, the intelligent IoE information framework may be directly mounted as an IoT gateway or an actuator to a smartphone by a container, a docker or another virtualization technology.

In particular, as shown in FIG. 20, a framework is expandable for dynamically requesting and executing a deep learning platform positioned in the central cloud server 20 or a microservice for processing each data.

That is, when various microservices needed according to IoE services are positioned on the central cloud server 20, according to one embodiment of the present invention, relevant microservices are requested and obtained on the basis of identifiers and driven by a virtual machine on the edge computing platform 100, thereby directly processing data generated in the IoT terminal 10.

To this end, the microservices supported on the framework materialized in the cloud server 20 are specified in the form of the identifier and registered in the edge identifier management node 200. Therefore, through the information networking technique using the existing edge identifier management node 200, the microservices required on the edge computing platform 100 are obtained and combined to perform necessary operations.

For example, in a case of a smart healthcare domain, data generated by a sensor of a user is susceptible to privacy violations. Therefore, the necessary data has to be made unidentifiable and preprocessed.

When there is such a defined service profile, models needed on the central cloud server 20 are dynamically requested in the form of microservices—a preprocessing service, an unidentifiable service, etc.—according to the service profiles, and the edge computing platform 100 is made to combine the services and process health data. Thus, the processed health data may be immediately reported to the user terminal 30 or directly forwarded to the cloud server 20, and thus subjected to additional processes.

Meanwhile, one embodiment of the present invention may be materialized by a computer program stored in a medium executed by a computer or a recording medium including a command executable by a computer. A computer readable medium may be a certain available medium accessed by a computer and may include all of volatile and nonvolatile media, and separable and nonseparable media. Further, the computer readable medium may include all of a computer storage medium and a communication medium. A computer storage medium includes all of volatile, nonvolatile, separable and nonseparable media materialized by a certain method or technology for storing information such as a computer readable command, a data structure, a program module or other data. The communication medium typically includes other data such as a computer readable command, a data structure, a program module, or a carrier wave and the like modulated data signal, or other transmission mechanisms and includes a certain information transmission medium.

According to one of the means for solving the foregoing problems of the present invention, information-centric networking (ICN) is included to directly provide connectivity to IoT terminals under a resource-constrained IoT environments, thereby checking integrity of IoT data while reducing overhead on a great deal of message exchanges and codes in the existing TCP/IP, TLS, and DTLS, and providing direct connectivity with the Layer 2 network.

Further, a URI form used in the existing application service is simply designed to also be directly used in the networking, and data is effectively collected through exchange of request/response (Interest/Content Object) messages.

Further, with the intelligent IoE information framework based on the edge computing platform for collecting, analyzing, filtering, etc. the data generated in the IoT terminal on the basis of the connectivity, it is possible to provide not only networking technology for transmitting the data, but also process and filter the data to be suitable for various IoE service domains and even provide an actual action command for the IoT terminal.

According to the present invention, it is possible to perform an expandable process for a lot of IoT terminals and data, support a low-latency service capable of supporting a time-critical IoE service like a plant safety service domain, and support various types of mobility such as user terminal mobility, IoT device mobility, data mobility, etc.

Further, the intelligent IoE information framework according to the present invention is mounted with an artificial intelligent engine for machine learning, reinforcement learning, etc., and thus provides a module and a component for analyzing and processing IoE data generated in real time.

Although the method and system according to the present invention are described in relation to specific embodiments, some or all elements or operations thereof may be materialized by a computer system having universal hardware architecture.

The foregoing descriptions of the present invention are given for illustrative purposes, and it will be appreciated by a person having an ordinary skill in the art to which the present invention pertains that changes into other specific embodiments can be made without departing from technical concept and essential features of the present invention. Therefore, it should be understood that the embodiments described above are not restricted but illustrative in all aspects. For example, each element described in a singular form may be materialized as separated, and the elements described as separated may be also materialized as coupled.

The scope of the present invention is defined by the appended claims rather than the above detailed descriptions, and it should be understood that all changes or alternatives from the meaning and scope of the appended claims and their equivalents are within the scope of the present invention.

What is claimed is:

1. A computing system for an intelligent Internet of Everything (IoE) information framework, the computer system comprising:
a plurality of edge computing platforms each comprising an edge networking node for supporting connectivity with a terminal, an intelligent computing node for analyzing data of the terminal through the edge networking node, and an edge gateway node for information-centric networking within an edge computing platform and Internet protocol networking with an outside of the edge computing platform; and
an edge identifier management node configured to generate mapping information by mapping the plurality of edge computing platforms with identifiers of the terminal and data.

2. The computing system according to claim 1, wherein the data of the terminal is stored in a temporary storage and classified according to the kinds of data and service, and the classified data is stored in a data storage in the edge computing platform and analyzed through the intelligent computing node.

3. The computing system according to claim 1, wherein the edge networking node registers identifier information as the identifier information is received from the terminal and connects with the terminal through bootstrapping of transmitting a response message.

4. The computing system according to claim 3, wherein the edge networking node transmits and registers the identifier information of the terminal to the intelligent computing node, and the intelligent computing node transmits and registers its own identifier information and the identifier information of the terminal to the edge identifier management node to maintain the mapping information.

5. The computing system according to claim 1, wherein the edge networking node of the edge computing platform at a user terminal among the plurality of edge computing platforms
receives identifier information of the intelligent computing node of the edge computing platform at an Internet of Things (IoT) terminal, in which the data of the IoT terminal is stored, from the edge identifier management node through the intelligent computing node as a message for requesting that the data of the IoT terminal is received from the user terminal, and
receives and provides one or more of data of the IoT terminal and the analyzed data from the intelligent computing node of the edge computing platform at the IoT terminal to the user terminal on the basis of the identifier information.

6. The computing system according to claim 1, wherein the edge gateway node receives a message for requesting the data of an Internet of Things (IoT) terminal from a cloud server, converts the received message into a message based on the information-centric networking, transmits the converted message to the intelligent computing node, receives one or more of data of the IoT terminal and the analyzed data from the intelligent computing node, converts the received data into a message based on the Internet protocol networking, and provides the converted message to the cloud server.

7. The computing system according to claim 1, wherein the edge gateway node receives a data processing model corresponding to a service profile from the cloud server as the service profile is transmitted to the cloud server through the Internet protocol networking, and the intelligent computing node analyzes the data on the basis of the received data processing model.

8. The computing system according to claim 1, wherein the data analyzed by the intelligent computing node is provided for an operation of the terminal or transmitted to the cloud server through the edge gateway node.

9. The computing system according to claim 1, wherein, when a first edge networking node to which a user terminal is connected is switched over to a second edge networking node as the user terminal moves within the edge computing platform,
the second edge networking node receives identifier information of the intelligent computing node from the edge identifier management node, transmits a message for requesting the data of an Internet of Things (IoT) terminal to the intelligent computing node on the basis of the received identifier information, and forwards one or more of the data of the IoT terminal and the analyzed data.

10. The computing system according to claim 1, wherein, when a first edge networking node to which an Internet of Things (IoT) terminal is connected is switched over to a second edge networking node as the IoT terminal moves within the edge computing platform,
the second edge networking node registers the IoT terminal to an intelligent computing node, and the intelligent computing node registers the IoT terminal to the edge identifier management node.

11. The computing system according to claim 10, wherein the intelligent computing node transmits a message to the second edge networking node to request the data of the IoT terminal and acquires the data of the IoT terminal.

12. The computing system according to claim 10, wherein the edge identifier management node generates the mapping information by mapping the identifier information of the IoT terminal and the identifier information of the intelligent computing node so as to perform a process with regard to a data request of the user terminal to the IoT terminal.

13. The computing system according to claim 1, wherein, when an Internet of Things (IoT) terminal moves from a first edge computing platform to a second edge computing platform among the plurality of edge computing platforms,
the edge networking node of the second edge computing platform registers the IoT terminal to the intelligent computing node, and the intelligent computing node of the second edge computing platform registers the IoT terminal to the edge identifier management node.

14. The computing system according to claim 13, wherein the intelligent computing node of the second edge computing platform transmits its own identifier and the identifier of the IoT terminal to the edge identifier management node, and the edge identifier management node maps the identifier of the IoT terminal and the identifier of the intelligent computing node to generate the mapping information.

15. The computing system according to claim 13 wherein, as the intelligent computing node of the second edge computing platform transmits a message for requesting data of the IoT terminal through the edge networking node of the second edge computing platform, the IoT terminal moved to the second edge computing platform provides the data to the intelligent computing node of the second edge computing platform through the edge networking node of the second edge computing platform.

16. The computing system according to claim 13, wherein, as movement of the IoT terminal to the second edge computing platform is completed, the intelligent computing node at the user terminal receives the identifier of the intelligent computing node of the second edge computing platform through the edge identifier management node and acquires the data of the IoT terminal through the intelligent computing node of the second edge computing platform.

17. The computing system according to claim 13, wherein the edge networking node of the second edge computing platform makes a request to the edge networking node of the first edge computing platform and forwards one or more of the data of the IoT terminal and the analyzed data, which are stored in the intelligent computing node of the first edge computing platform, to the intelligent computing node of the second edge computing platform.

18. A computing method of an intelligent Internet of Everything (IoE) information framework, the computing method comprising:
receiving data of a terminal using an edge networking node for supporting connectivity with the terminal;
collecting and analyzing the received data of the terminal using an intelligent computing node; and
transmitting the analyzed data to a cloud server through an edge gateway node or providing the analyzed data as operation data for the terminal through the intelligent computing node,
wherein the intelligent IoE information framework comprises a plurality of edge computing platforms, each of which comprises the edge networking node, the intelligent computing node, and the edge gateway node, and an edge identifier management node configured to generate mapping information by mapping the plurality of edge computing platforms with identifiers of the terminal and data.

19. An edge computing platform apparatus in an intelligent Internet of Everything (IoE) information framework, the apparatus comprising
an edge networking node for supporting connectivity with a terminal;
an intelligent computing node for analyzing data of the terminal through the edge networking node; and
an edge gateway node for information-centric networking and Internet protocol networking with an outside.
